(19) United States
(12) Patent Application Publication
(10) Pub. No.: US 2025/0199789 A1
(43) Pub. Date: Jun. 19, 2025

(54) INFORMATION PROCESSING APPARATUS AND INFORMATION PROCESSING SYSTEM

(71) Applicant: SONY SEMICONDUCTOR SOLUTIONS CORPORATION, KANAGAWA (JP)

(72) Inventors: YOSHIHIRO KUMAGAI, KANAGAWA (JP); MUNEHIRO SHIMOMURA, KANAGAWA (JP)

(21) Appl. No.: 18/849,528

(22) PCT Filed: Mar. 10, 2023
(86) PCT No.: PCT/JP2023/009424

§ 371 Date: Sep. 22, 2024

(30) Foreign Application Priority Data
Mar. 30, 2022 (JP) 2022-056221

(51) Int. Cl. G06F 8/60; G08G 1/09

(52) U.S. Cl. CPC G06F 8/60; G08G 1/09

(57) ABSTRACT

An information processing apparatus according to the present technology includes an information acquiring section that acquires information from a sensor of an edge-side information processing apparatus that performs an inference process using an artificial intelligence model, a model selecting section that selects an artificial intelligence model to be deployed on the edge-side information processing apparatus, on the basis of purpose information set by a user and the information acquired from the sensor, and a transmission processing section that performs transmission control for transmitting the selected artificial intelligence model to the edge-side information processing apparatus, on the basis of a confirmation result of purchase information regarding the selected artificial intelligence model in an account associated with the user.

### TECHNICAL FIELD

The present technology relates to a technical field of information processing apparatuses that handle artificial intelligence models.

### BACKGROUND ART

Although artificial intelligence models are progressing day by day, information processing apparatuses such as camera apparatuses on which artificial intelligence models are deployed use older artificial intelligence models to perform inference processes unless updating work is performed manually.

Updating of artificial intelligence models is an important problem, and, for example, PTL 1 described below discloses a configuration for seamlessly switching artificial intelligence models of different versions in an information processing apparatus.

### CITATION LIST

### Patent Literature

### [PTL 1]

Japanese Patent laid-open No. 2021-68442

### SUMMARY

### Technical Problem

Meanwhile, inference processes that are desired to be performed and results of inference that are desired to be obtained with an information processing apparatus are different depending on the time and situation, in some cases. In such a case, it is necessary not only to update the version of an artificial intelligence model but also to switch to an artificial intelligence model of a different type.

The present technology has been made in view of such a problem, and an object thereof is to provide an environment where artificial intelligence models appropriate for purposes can be used at edge-side information processing apparatuses.

### Solution to Problem

An information processing apparatus according to the present technology includes an information acquiring section that acquires information from a sensor of an edge-side information processing apparatus that performs an inference process using an artificial intelligence model, a model selecting section that selects an artificial intelligence model to be deployed on the edge-side information processing apparatus, on the basis of purpose information set by a user and the information acquired from the sensor, and a transmission processing section that performs transmission control for transmitting the selected artificial intelligence model to the edge-side information processing apparatus, on the basis of a confirmation result of purchase information regarding the selected artificial intelligence model in an account associated with the user.

Accordingly, it becomes possible to select and deploy an artificial intelligence model for acquiring desired information, on the basis of information obtained from the edge-side information processing apparatus.

### BRIEF DESCRIPTION OF DRAWINGS

FIG. 1 is a figure depicting a configuration example of an information processing system.

FIG. 2 is a figure for explaining each piece of equipment that registers or downloads AI models or AI applications via a marketplace function of a cloud-side information processing apparatus.

FIG. 3 is a figure depicting an example of a processing procedure executed by each apparatus when an AI model and an AI application are registered or downloaded via the marketplace function.

FIG. 4 is a figure depicting an example of a processing procedure executed by each apparatus when an AI application and an AI model are deployed.

FIG. 5 is a flowchart depicting an example of a process executed at a camera.

FIG. 6 is a flowchart depicting an example of a process executed at the cloud-side information processing apparatus.

FIG. 7 is a flowchart depicting another example of the process executed at the camera.

FIG. 8 is a flowchart depicting another example of the process executed at the cloud-side information processing apparatus.

FIG. 9 is a flowchart depicting still another example of the process executed at the camera.

FIG. 10 is a flowchart depicting still another example of the process executed at the cloud-side information processing apparatus.

FIG. 11 is a figure for explaining a manner of connection between the cloud-side information processing apparatus and an edge-side information processing apparatus.

FIG. 12 is a functional block diagram of the cloud-side information processing apparatus.

FIG. 13 is a figure depicting a configuration example of a camera service function.

FIG. 14 is a block diagram depicting an internal configuration example of the camera.

FIG. 15 is a figure depicting a configuration example of an image sensor.

FIG. 16 is a block diagram depicting a software configuration of the camera.

FIG. 17 is a block diagram depicting an operating environment of containers in a case where a container technology is used.

FIG. 18 is a block diagram depicting an example of a hardware configuration of an information processing apparatus.

FIG. 19 is a figure for explaining a processing procedure in other explanation.

FIG. 20 is a figure depicting an example of a login screen for logging in to a marketplace.

FIG. 21 is a figure depicting an example of a developer screen presented to each developer who uses the marketplace.

FIG. 22 is a figure depicting an example of a user screen presented to an application user who uses the marketplace.

### DESCRIPTION OF EMBODIMENTS

Hereinbelow, an embodiment of an information processing apparatus according to the present technology is explained in the following order with reference to the attached figures.
<1. Overall Configuration of Information Processing System>
<2. Registration of AI Model and AI Application>
<3. Deployment of AI Application and AI Model>
<4. Function Overview of System>
<5. Configuration of Image Capturing Apparatus>
<6. Hardware Configuration of Information Processing Apparatus>
<7. Others>
<8. Examples of Screens of Marketplace>
<9. Summary>
<10. Present Technology>

### <1. Overall Configuration of Information Processing System>

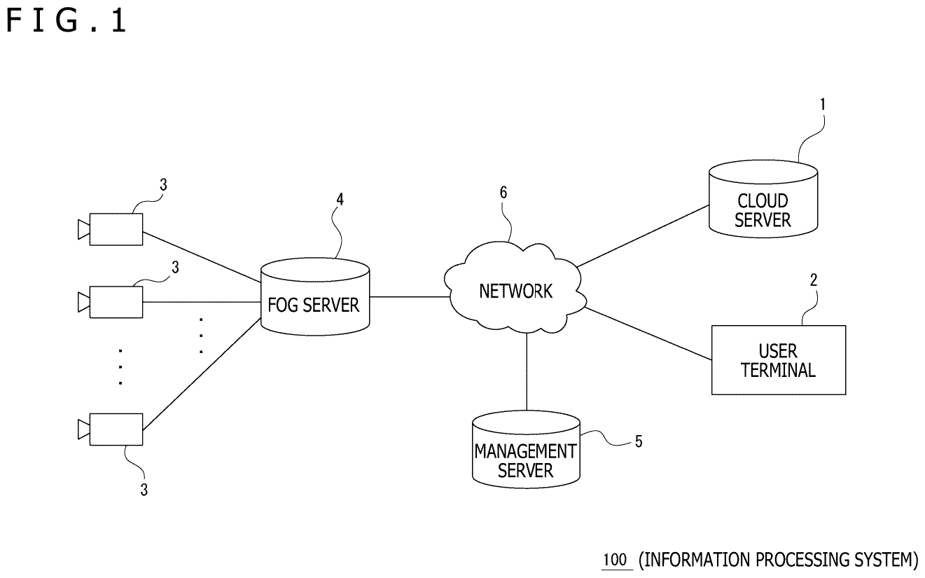

FIG. 1 is a block diagram depicting a schematic configuration example of an information processing system 100 as an embodiment according to the present technology.

As depicted in the figure, the information processing system 100 includes a cloud server 1, user terminals 2, multiple cameras 3, a fog server 4, and a management server 5. In the present example, the cloud server 1, the user terminals 2, the fog server 4, and the management server 5 are capable of mutual communication via a network 6 such as the Internet, for example.

The cloud server 1, the user terminals 2, the fog server 4, and the management server 5 are each configured as an information processing apparatus including a microcomputer having a CPU (Central Processing Unit), a ROM (Read Only Memory), and a RAM (Random Access Memory).

Here, the user terminals 2 are information processing apparatuses that are expected to be used by users who are recipients of services using the information processing system 100. In addition, the management server 5 is an information processing apparatus that is expected to be used by a provider of services.

For example, each camera 3 includes an image sensor such as a CCD (Charge Coupled Device) type image sensor or a CMOS (Complementary Metal Oxide Semiconductor) type image sensor, captures images of subjects, and obtains image data (captured image data) as digital data.

For example, a sensor included in a camera 3 is an RGB sensor that captures RGB images, a distance measurement sensor that outputs distance images, or the like.

In addition, as mentioned later, each camera 3 also has a function to perform a process using AI (Artificial Intelligence) (e.g., an image recognition process, an image detection process, etc.) on captured images. In the following explanation, various processes on images such as an image recognition process or an image detection process are referred to simply as “image processing.” For example, various processes on images by use of AI (or an AI model) are referred to as “AI image processing.”

Each camera 3 is capable of data communication with the fog server 4 and, for example, is capable of transmitting, to the fog server 4, various types of data such as processing result information representing results of processes (image processing, etc.) using AI, receiving various types of data from the fog server 4, and so on.

Here, for example, the information processing system 100 depicted in FIG. 1 is expected to be used to cause the fog server 4 or the cloud server 1 to generate analysis information regarding subjects on the basis of processing result information obtained by image processing performed by each camera 3, and allow a user to view the generated analysis information via its user terminal 2.

In this case, each camera 3 can be used as a vehicle-mounted camera. A camera 3 as a vehicle-mounted camera obtains information regarding a road condition (traffic amount or road surface condition) by inputting captured images of the outside of a vehicle to an AI model. Analysis information in this case is analysis information regarding the road surface condition of each area, analysis information regarding traffic jams, and the like.

Note that the “road surface condition” may include not only the road surface conditions of roads but also conditions related to fallen street trees, conditions related to water flooding from roadside drainage holes, and the like.

In addition, by using an AI model that detects, on captured images, fuel prices put up outside shops at gas stations, information regarding fuel prices of an area where a vehicle having a camera 3 mounted thereon is traveling can be obtained. Analysis information in this case is analysis information regarding fuel prices of each area.

In addition, each camera 3 may be used as any of various monitoring cameras. For example, the cameras 3 can be used as monitoring cameras for indoor spaces such as stores, offices, or houses, monitoring cameras (including traffic monitoring cameras and the like) for monitoring outdoor spaces at parking lots, in town, and so on, monitoring cameras of manufacturing lines in FA (Factory Automation) or IA (Industrial Automation), monitoring cameras that monitor insides of vehicles or outsides of vehicles, and the like.

For example, in a case where the cameras 3 are used as monitoring cameras in a store, it is possible that each of the multiple cameras 3 is arranged at a predetermined position in the store, and a user is allowed to check customer segments (genders, age brackets, etc.) of in-store customers, behaviors (the lines of flow) of the in-store customers in the store, and the like. In that case, it is possible that, as the analysis information described above, information regarding the customer segments of the in-store customers, information regarding the lines of flow of the in-store customers in the store, information regarding the congestion state at payment cash registers (e.g., waiting time at the payment cash registers), and the like are generated.

Alternatively, in a case where the cameras 3 are used as traffic monitoring cameras, it is possible that each camera 3 is arranged at a position near a road, and a user is allowed to recognize information such as the number (vehicle number), vehicle color, or vehicle model of a passing vehicle. In that case, it is possible that, as the analysis information described above, information such as the number, the vehicle color, or the vehicle model is generated.

In addition, in a case where traffic monitoring cameras are used in a parking lot, it is possible that the cameras are arranged such that they can monitor each parked vehicle, monitor whether there is a suspicious person who is behaving suspiciously around each vehicle, and so on, and, in a case where there is a suspicious person, issues a notification that there is a suspicious person, or issues a notification regarding the attribute (gender, age bracket) of the suspicious person, or the like.

Further, it is also possible that available spaces in town or a parking lot are monitored, and a user is notified of the location of a space where she/he can park her/his vehicle.

For example, the fog server 4 is expected to be arranged for each area in the example of the cameras 3 as vehicle-mounted cameras. The fog server 4 relays communication of information between the cameras 3 mounted on vehicles traveling in a predetermined area and the cloud server 1. By providing the fog server 4 for each area in this manner, it becomes unnecessary for the cloud server 1 to directly receive transmission data from the multiple cameras 3, and it is possible to reduce a processing load on the cloud server 1.

In addition, in the example of the cameras 3 as monitoring cameras, for example, in the case of the use for monitoring of a store described above, the fog server 4 is expected to be arranged for each monitoring target such as being arranged in a monitoring-target store along with each camera 3. By providing the fog server 4 for each monitoring target such as a store in this manner, it becomes unnecessary for the cloud server 1 to directly receive transmission data from the multiple cameras 3 at the monitoring target, and it is possible to reduce the processing load on the cloud server 1.

Note that it is also possible that, in a case where there are multiple monitoring-target stores and all the stores belong to the same chain, the fog server 4 is not provided for each store but provided singly for the multiple stores. That is, the fog server 4 is not necessarily provided for each monitoring target, and can be provided singly for multiple monitoring targets.

Note that, in a case where the cloud server 1 or each camera 3 can function as the fog server 4 for reasons such as that the cloud server 1 or each camera 3 has a processing ability, the fog server 4 may be omitted from the information processing system 100, each camera 3 may be connected directly to the network 6, and transmission data from the multiple cameras 3 may be received directly by the cloud server 1.

Note that, in a case where the cameras 3 are vehicle-mounted cameras, for example, the fog server 4 is expected to be an apparatus managed by a vehicle manufacturer.

Various apparatuses described above can be roughly classified into cloud-side information processing apparatuses and edge-side information processing apparatuses in the following explanation.

The cloud-side information processing apparatuses are the cloud server 1 and the management server 5 and constitute an apparatus group that provides services that are expected to be used by multiple users.

In addition, the edge-side information processing apparatuses are the cameras 3 and the fog server 4 and can be understood as an apparatus group arranged in an environment prepared by a user who uses a cloud service.

It should be noted that both the cloud-side information processing apparatuses and the edge-side information processing apparatuses may be in an environment prepared by the same user.

Note that the fog server 4 may be an on-premises server.

### <2. Registration of AI Model and AI Application>

As mentioned above, in the information processing system 100, the cameras 3, which are edge-side information processing apparatuses, perform AI image processing, and the cloud server 1, which is a cloud-side information processing apparatus, realizes an advanced application function using information regarding results of the edge-side AI image processing (e.g., information regarding results of image recognition processes using AI).

Here, there are various possible approaches to registration of an application function in the cloud server 1 (or including the fog server 4), which is a cloud-side information processing apparatus.

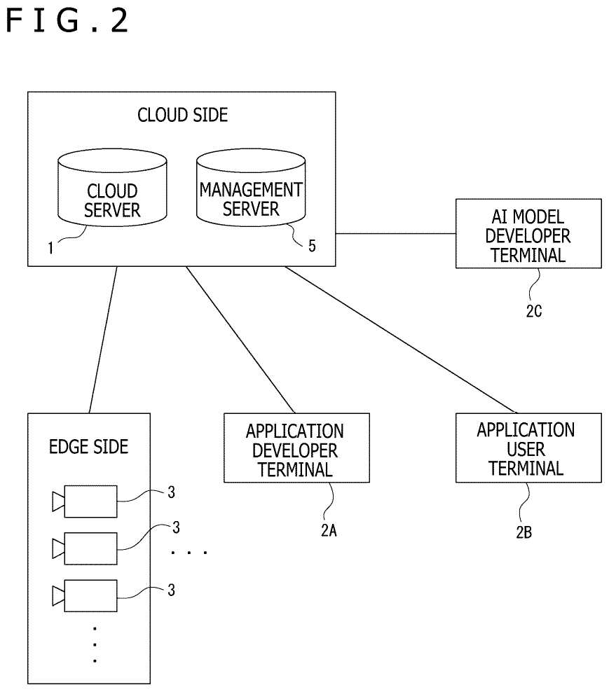

An example thereof is explained with reference to FIG. 2.

Note that, although the fog server 4 is omitted in FIG. 2, a configuration including the fog server 4 may be adopted. The fog server 4 at that time may bear some of edge-side functions.

The cloud server 1 and the management server 5 mentioned above are information processing apparatuses included in a cloud-side environment.

In addition, the cameras 3 are information processing apparatuses included in an edge-side environment.

Note that the cameras 3 can each be understood as being an apparatus including a control section that performs overall control of the camera 3, and also as being an apparatus including another apparatus as an image sensor IS including a computation processing section that performs various processes including AI image processing on captured images. That is, the cameras 3, which are edge-side information processing apparatuses, may each be understood as having, mounted therein, the image sensor IS, which is another edge-side information processing apparatus.

In addition, the user terminals 2 to be used by the users who use various services provided by the cloud-side information processing apparatuses include an application developer terminal 2A used by a user who develops an application used for AI image processing, an application user terminal 2B used by a user who uses an application, an AI model developer terminal 2C used by a user who develops an AI model used for AI image processing, and the like.

Note that, needless to say, the application developer terminal 2A may be used by a user who develops an application that does not use AI image processing.

On a cloud-side information processing apparatus, training datasets for performing training of AI are prepared. The user who develops an AI model communicates with the cloud-side information processing apparatus by use of the AI model developer terminal 2C and downloads the training datasets. At this time, the training datasets may be provided for a fee. For example, the AI model developer may register personal information in a marketplace (electronic market) prepared as a cloud-side function, thereby making it possible for her/him to purchase various functions or materials registered in the marketplace, and may then purchase the training datasets.

After developing an AI model by use of the training datasets, the AI model developer uses the AI model developer terminal 2C to register, in the marketplace, the AI model having been developed. The AI model developer may consequently be paid an incentive when the AI model is downloaded.

In addition, the user who develops an application downloads an AI model from the marketplace by use of the application developer terminal 2A and develops an application (hereinafter, referred to as an “AI application”) that uses the AI model. At this time, as mentioned before, the AI model developer may be paid an incentive.

Using the application developer terminal 2A, the application development user registers, in the marketplace, the AI application having been developed. The user who has developed the AI application may consequently be paid an incentive when the AI application is downloaded.

Using the application user terminal 2B, the user who uses an AI application performs operation for deploying an AI application and an AI model from the marketplace to a camera 3 as an edge-side information processing apparatus managed by her/himself. At this time, an AI model developer may be paid an incentive.

Accordingly, it becomes possible for the camera 3 to perform AI image processing using the AI application and the AI model, and it becomes possible for the camera 3 to not only capture images but also acquire road conditions (road surface conditions and traffic jam conditions), acquire fuel prices, detect in-store customers, or detect vehicles by AI image processing.

Here, the deployment of the AI application and the AI model means installation of the AI application and the AI model onto a target (apparatus) as an executing section such that the target as the executing section can use the AI application and the AI model, stated differently, such that the target as the executing section can execute at least some programs as the AI application.

In addition, it may be made possible for the camera 3 to extract, by AI image processing, attribute information regarding in-store customers from captured images captured at the camera 3.

The attribute information is transmitted from the camera 3 to a cloud-side information processing apparatus via the network 6.

Cloud applications are deployed on the cloud-side information processing apparatus, and each user is allowed to use the cloud applications via the network 6. Then, map applications for displaying road conditions or fuel price information on maps, navigation applications for providing optimum route information, applications that analyze the lines of flow of in-store customers by using attribute information regarding the in-store customers and captured images, and the like are prepared as the cloud applications. Such cloud applications are uploaded by an application development user or the like.

By using a cloud application for viewing route information or a cloud application for obtaining navigation by use of the application user terminal 2B, the application user is allowed to view information necessary for driving and information necessary for refueling. In addition, the application user is allowed to analyze the lines of flow of in-store customers of her/his store and view analysis results by using a cloud application for line-of-flow analysis by use of the application user terminal 2B. For example, the analysis results are viewed as a recommended route displayed in a superimposed manner on a map, the lines of flow of in-store customers graphically presented on a store map, and the like.

In addition, the viewing of the analysis results may be achieved by display of results of the line-of-flow analysis in the form of a heat map and presentation of the density of the in-store customers or the like.

In addition, these pieces of information may be displayed in such a manner that they are sorted by attribute information regarding the in-store customers.

On the cloud-side marketplace, an AI model optimized for each user may be registered. For example, captured images captured at a camera 3 arranged in a store managed by a user are uploaded to and accumulated in a cloud-side information processing apparatus as appropriate.

The cloud information processing apparatus executes a process of performing a retraining process of an AI model, updating the AI model, and re-registering the AI model in the marketplace every time the number of uploaded and accumulated captured images reaches a certain number.

Note that, for example, a user may be allowed to select the retraining process of an AI model as an option on the marketplace.

For example, it is possible to enhance a recognition rate and the like of image processing on captured images captured at a dark location, by deploying, on a camera 3 arranged in a store, an AI model retrained using dark images from the camera 3. In addition, it is possible to enhance the recognition rate and the like of image processing on images captured at a bright location, by deploying, on a camera 3 arranged outside a store, an AI model retrained using bright images from the camera 3.

That is, it becomes possible for an application user to always obtain optimized processing result information, by re-deploying an updated AI model on a camera 3 again.

Note that the retraining process of an AI model is mentioned later on.

In addition, on the cloud-side marketplace, an AI model optimized for each camera may be registered. For example, it is possible that there are an AI model to be applied to a camera 3 that can acquire RGB images, an AI model to be applied to a camera 3 including a distance measurement sensor that generates distance images, and the like.

In addition, an AI model trained using captured images of vehicles and pedestrians in bright environments as an AI model that should be used at a camera 3 mounted on a vehicle traveling before dark, and an AI model trained using captured images of vehicles and pedestrians in dark environments as an AI model that should be used at a camera 3 mounted on a vehicle traveling after dark may be registered in the marketplace.

Then, it is desirable that these AI models be updated as appropriate to be AI models with recognition rates enhanced by the retraining process.

In addition, in a case where personal information is included in the information (captured images, etc.) uploaded from a camera 3 to a cloud-side information processing apparatus, from the perspective of protection of privacy, data from which information related to privacy has been deleted may be uploaded, or data from which information related to privacy has been deleted may be made available to an AI model development user or an application development user.

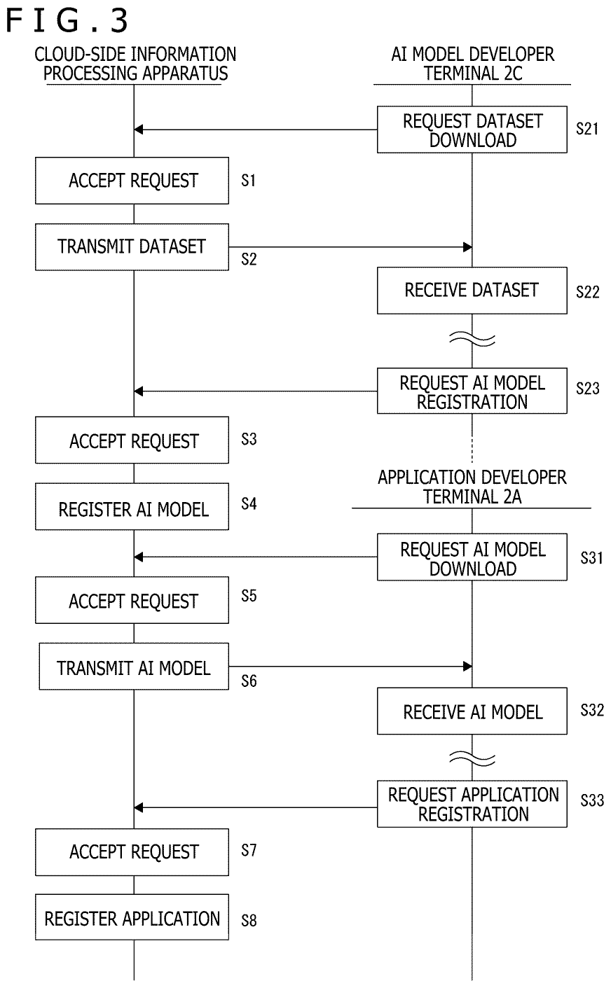

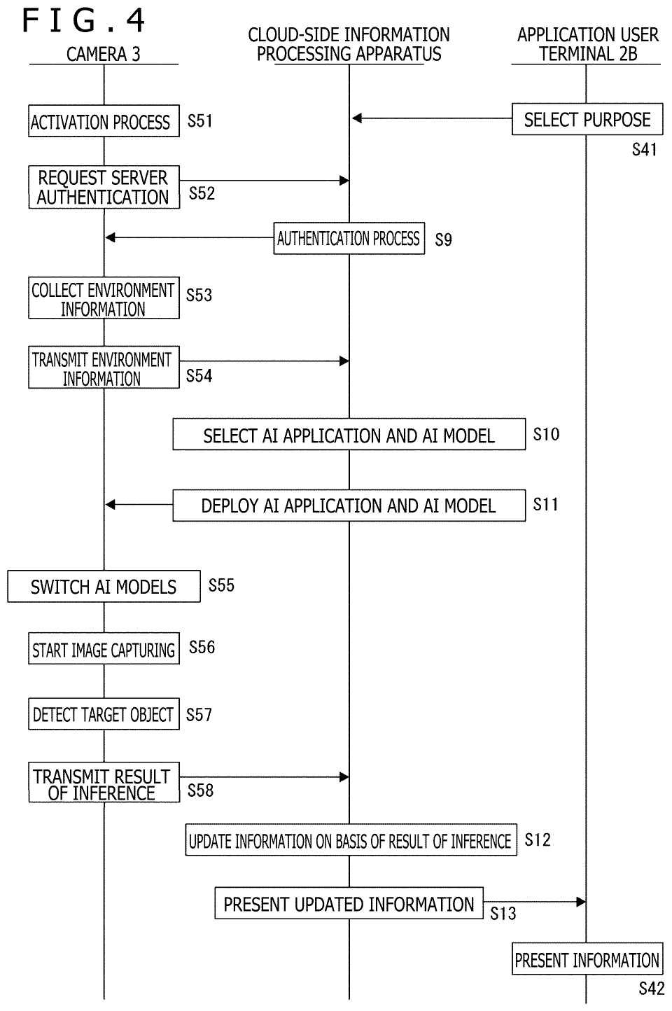

The processing procedure described above is depicted as flowcharts in FIG. 3 and FIG. 4.

Note that a cloud-side information processing apparatus corresponds to the cloud server 1, the management server 5, or the like in FIG. 1.

When the AI model developer views a list of datasets registered in the marketplace, by using the AI model developer terminal 2C having a display section including an LCD (Liquid Crystal Display), an organic EL (Electro Luminescence) panel, or the like, and selects a desired dataset, at step S21, the AI model developer terminal 2C transmits a request for downloading the selected dataset to a cloud-side information processing apparatus.

In response to this, at step S1, the cloud-side information processing apparatus accepts the request and, at step S2, performs a process of transmitting the requested dataset to the AI model developer terminal 2C.

At step S22, the AI model developer terminal 2C performs a process of receiving the dataset. It thus becomes possible for the AI model developer to develop an AI model by using the dataset.

When the AI model developer has finished developing the AI model and thereafter performs operation for registering, in the marketplace, the AI model having been developed (e.g., designating the name of the AI model, the address where the AI model is located, and the like), at step S23, the AI model developer terminal 2C transmits a request for registering the AI model in the marketplace to the cloud-side information processing apparatus.

In response to this, at step S3, the cloud-side information processing apparatus accepts the registration request and, for example, can cause the AI model to be displayed on the marketplace by performing a process of registering the AI model at step S4. It thus becomes possible for users other than the AI model developer to download the AI model from the marketplace.

For example, the application developer who is going to develop an AI application views a list of AI models registered in the marketplace, by using the application developer terminal 2A. At step S31, according to operation by the application developer (e.g., operation of selecting one of AI models on the marketplace), the application developer terminal 2A transmits a request for downloading the selected AI model to the cloud-side information processing apparatus.

At step S5, the cloud-side information processing apparatus accepts the request and, at step S6, transmits the AI model to the application developer terminal 2A.

At step S32, the application developer terminal 2A receives the AI model. It thus becomes possible for the application developer to develop the AI application using the AI model developed by another person.

When the application developer finished developing the AI application and thereafter performs operation for registering the AI application in the marketplace (e.g., operation of designating the name of the AI application, the address where the AI application is located, and the like), at step S33, the application developer terminal 2A transmits a request for registering the AI application to the cloud-side information processing apparatus.

At step S7, the cloud-side information processing apparatus accepts the registration request and, for example, can cause the AI application to be displayed on the marketplace by performing registration of the AI application at step S8. It thus becomes possible for users other than the application developer to select the AI application on the marketplace and download the AI application.

### <3. Deployment of AI Application and AI Model>

As depicted in FIG. 4, at step S41, the user who wants to use an AI application performs purpose selection using the application user terminal 2B. In the purpose selection, a selected purpose is transmitted to the cloud-side information processing apparatus.

For example, the purpose selected here includes “recognizing road surface condition” or “recognizing traffic jam condition” that would be selected when a disaster has occurred, “recognizing fuel prices of each area” that would be selected by a user who cares gasoline prices, and the like.

The selected purpose is transmitted to the cloud-side information processing apparatus to be set at the cloud-side information processing apparatus. At the cloud-side information processing apparatus, the set purpose information is used for selection of an AI model thereafter.

Note that, for example, the purpose information can be said differently as information for identifying a purpose of use of information regarding results of an inference process performed at a camera 3. For example, in a case where it is estimated as a result of an inference process that an accident-involved vehicle is captured in an image captured with a camera 3, information regarding an accident situation is updated using the result of inference and provided to the user. Purpose information at this time can be said to be a purpose of use of the result of inference regarding the accident-involved vehicle, and can be said to be updating of the information regarding the accident situation or provision of the information regarding the accident situation to the user.

The camera 3 performs an activation process at step S51. For example, at the camera 3 as a vehicle-mounted camera, an activation process is performed in response to the activation of an engine of a vehicle.

At step S52, the camera 3 performs a process of requesting server authentication. Specifically, in order for the camera 3 to be authenticated as a genuine apparatus such that the camera 3 appropriately performs processes such as updating of an AI model, the camera 3 transmits information regarding the apparatus to the cloud-side information processing apparatus.

In response to this, at step S9, the cloud-side information processing apparatus executes an authentication process and transmits, to the camera 3, a result of the authentication process, that is, information representing whether or not the authentication is successful or not.

If the authentication is successful, the camera 3 performs environment information collection at step S53 and transmits acquired environment information to the cloud-side information processing apparatus at step S54.

Here, for example, the environment information collected by the camera 3 includes the model number of the camera 3, information regarding the type of the image sensor included in the camera 3, the version an AI model being deployed, positional information regarding the camera 3 (which can also be said as positional information regarding the vehicle in the case of the vehicle-mounted camera 3), weather information or brightness information which is sensing information regarding the outside of the vehicle, and the like.

These pieces of information are used at the cloud-side information processing apparatus for selecting an optimum AI model or the like according to the purpose.

That is, at step S10, the cloud-side information processing apparatus selects an AI application and an AI model according to the purpose information set at step S41 and the environment information received from the camera 3.

At step S11, the cloud-side information processing apparatus performs a process of deploying the AI application and the AI model. The deployment of the AI application and the AI model may be performed taking into consideration on which apparatus each SW (Software) component included in the AI application and the AI model for achieving the purpose is to be deployed, and so on. That is, the entire AI application and AI model may not necessarily be deployed on the camera 3.

Each SW component may be a container mentioned later or may be a microservice. Note that it is possible to realize SW components also by using a WebAssembly technology.

Note that, in the deployment process at step S11, it may be confirmed first whether or not the AI model and the AI application that are planned to be deployed have been purchased by the user.

For example, in a case where the AI model and the AI application that are planned to be deployed have already been purchased by the user, the deployment process is performed promptly. In a case where the AI model and the AI application that are planned to be deployed have not been purchased by the user, on the other hand, the deployment process may be performed after a process of confirming with the user whether or not she/he purchases the AI model and the AI application or a purchase process (payment process) is performed. At this time, an account associated with the user is associated with the purchased AI model and AI application as mentioned later.

In response to the deployment of the AI application and the AI model on the cloud-side information processing apparatus, at step S55, the camera 3 performs a process of deploying the AI application and the AI model and performs a process of switching to the newly deployed AI application and AI model. Accordingly, it becomes possible to perform new AI image processing on captured images captured at the camera 3.

At step S56, the camera 3 starts image capturing.

At step S57, the camera 3 detects target objects. For example, the target objects are cracks or depressions generated on road surfaces, fallen trees having fallen onto road surfaces, and the like in a case where the purpose is to recognize the road surface condition. Alternatively, in a case where the purpose is to recognize the traffic jam condition, the target objects are other vehicles, accident-involved vehicles, and the like around the vehicle. Further alternatively, in a case where the purpose is to recognize fuel prices of each area, the target objects are signboards of gas stations, displayed objects on which fuel prices are displayed, and the like.

At step S58, the camera 3 transmits target object detection results, that is, results of inference, to the cloud-side information processing apparatus.

At step S12, the cloud-side information processing apparatus updates various types of information on the basis of the received results of inference.

At step S13, the cloud-side information processing apparatus performs a process of presenting the updated information.

As a result, for example, a process of causing a monitor or the like of the application user terminal 2B or the like to display the updated information is performed.

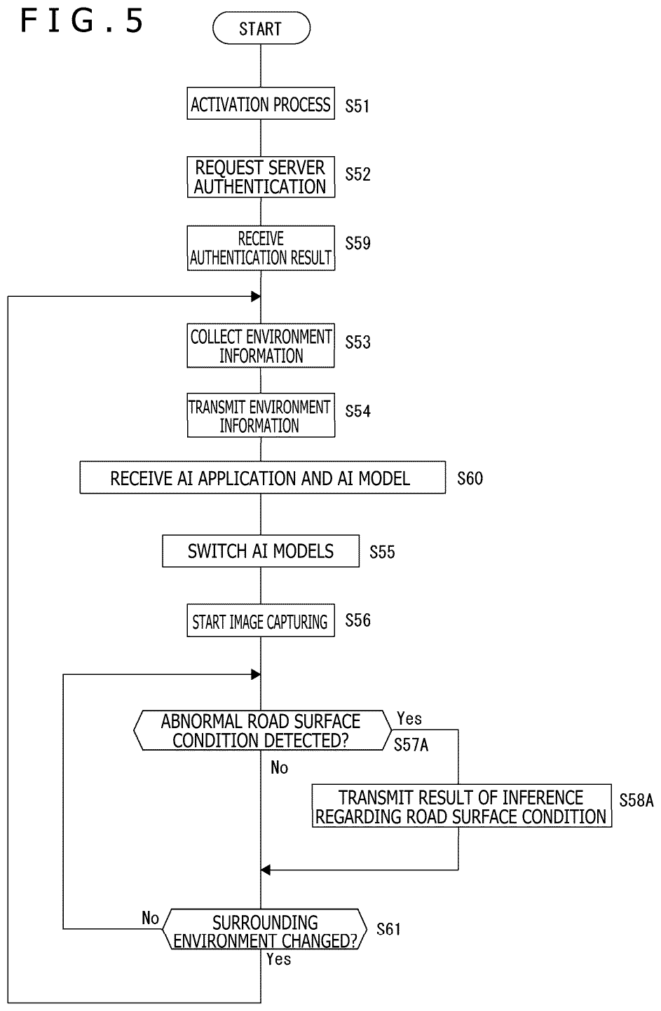

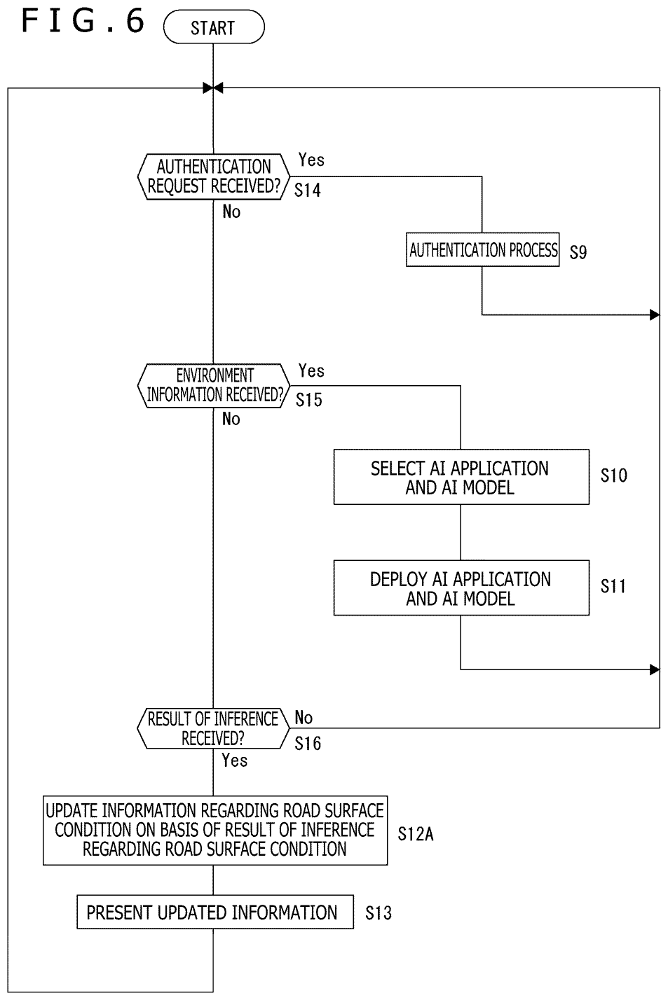

FIG. 5 and FIG. 6 depict flowcharts regarding processes executed at the camera 3 and the cloud-side information processing apparatus in order to realize the processing procedure in FIG. 4. Note that explanations overlapping those described with reference to FIG. 4 are omitted as appropriate.

FIG. 5 is a flowchart of a process executed by the computation processing section of the camera 3 for the purpose to recognize the road surface condition.

The camera 3 performs an activation process at step S51 and makes a server authentication request at subsequent step S52.

At step S59, the camera 3 receives an authentication result. Note that, in a case where the result received at step S59 represents an unsuccessful authentication, a notification to that effect may be given to a driver.

In a case where the authentication is successful, the camera 3 collects environment information at step S53 and transmits the environment information to the cloud-side information processing apparatus at step S54.

Next, at step S60, the camera 3 receives an AI application and an AI model from the cloud-side information processing apparatus. Note that this process is not essential, and, in a case where the AI application and the AI model selected at the cloud-side information processing apparatus have already been deployed on the camera 3, the process at step S60 may not be executed.

At step S55, the camera 3 performs switching of AI models.

At step S56, the camera 3 starts image capturing.

At step S57A, the camera 3 determines whether or not an abnormal road surface condition has been detected, by performing an inference process using captured images.

In a case where it is determined that an abnormal road surface condition has been detected, at step S58A, the camera 3 transmits a result of inference regarding the road surface condition to the cloud-side information processing apparatus.

On the other hand, in a case where it is determined that an abnormal road surface condition has not been detected, at step S61, the camera 3 determines whether or not the surrounding environment has changed. For example, in a case it starts to rain suddenly, in a case where the sun has set and it has gotten dark around the vehicle, or in another case, it is determined that the surrounding environment has changed.

In this case, the camera 3 returns to the process at step S53 and collects environment information.

The cloud-side information processing apparatus thus selects an optimum AI model again and deploys the AI model on the camera 3. Accordingly, it becomes possible for the camera 3 to continue an appropriate inference process according to the changed surrounding environment.

Note that, in a case where it is determined at step S61 that the surrounding environment has not changed, the camera 3 returns to the determination process at step S57A again.

FIG. 6 is a flowchart of a process executed by a computation processing section of the cloud-side information processing apparatus for the purpose to recognize the road surface condition.

At step S14, the cloud-side information processing apparatus determines whether or not an authentication request has been received. In a case where it is determined that an authentication request has been received, at step S9, the cloud-side information processing apparatus executes the authentication process and transmits an authentication result to the requester apparatus (camera 3). Thereafter, the cloud-side information processing apparatus returns to the process at step S14.

At step S15, the cloud-side information processing apparatus having determined at step S14 that an authentication request has not been received determines whether or not environment information has been received, that is, whether or not environment information transmitted from the camera 3 at step S54 in FIG. 5 has been received.

In a case where it is determined that environment information has been received, the cloud-side information processing apparatus selects an AI application and an AI model at step S10 and deploys the selected AI application and AI model at subsequent step S11. Then, the cloud-side information processing apparatus returns to the process at step S14.

On the other hand, in a case where it is determined at step S15 that environment information has not been received, at step S16, the cloud-side information processing apparatus determines whether or not a result of inference has been received.

In a case where it is determined that a result of inference has been received, at step S12A, the cloud-side information processing apparatus updates information regarding the road surface condition on the basis of the result of inference regarding the road surface condition.

Then, at step S13, the cloud-side information processing apparatus presents, to the user, the updated information by using the user terminal 2.

In this manner, the series of processes depicted in FIG. 4 can be realized by causing the computation processing section of the camera 3 to execute the respective processes depicted in FIG. 5, and causing the computation processing section of the cloud-side information processing apparatus to execute the respective processes depicted in FIG. 6.

Next, processes executed by the camera 3 and the cloud-side information processing apparatus for the purpose to recognize fuel prices of each area are explained.

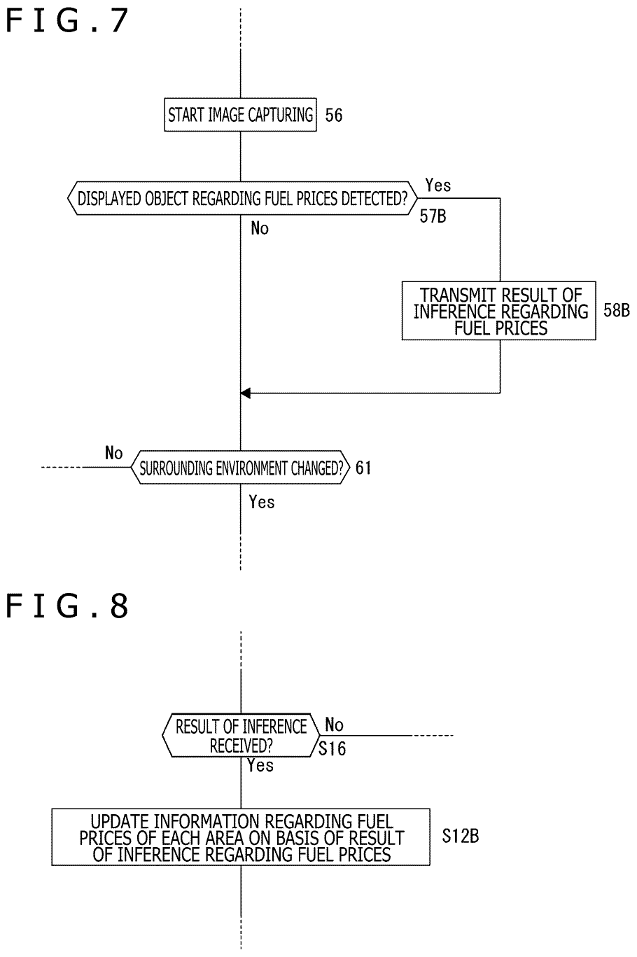

FIG. 7 depicts processes executed by the computation processing section of the camera 3. Note that the respective processes depicted in FIG. 7 are only some of processes executed by the computation processing section of the camera 3 after the process at step S56 in FIG. 5, other processes are similar to those in FIG. 5, and accordingly, explanations thereof are omitted.

After the camera 3 starts image capturing at step S56, at step S57B, the camera 3 determines whether or not a displayed object regarding fuel prices has been detected. For example, the displayed object regarding fuel prices means an object such as a signboard or a signboard pole of a gas station on which fuel prices are displayed.

In a case where it is determined that a displayed object regarding fuel prices has been detected, at step S58B, the camera 3 transmits a result of inference regarding fuel prices to the cloud-side information processing apparatus, and the procedure proceeds to the process at step S61.

On the other hand, in a case where it is determined that a displayed object regarding fuel prices has not been detected, the camera 3 does not execute the process at step S58B, and the procedure proceeds to the process at step S61.

FIG. 8 depicts processes executed by the computation processing section of the cloud-side information processing apparatus. Note that the respective processes depicted in FIG. 8 are only some of processes executed by the computation processing section of the cloud-side information processing apparatus after the process at step S16 in FIG. 6, other processes are similar to those in FIG. 6, and accordingly, explanations thereof are omitted.

At step S16, the cloud-side information processing apparatus determines whether or not a result of inference has been received. In a case where it is determined that a result of inference has been received, at step S12B, the cloud-side information processing apparatus updates information regarding fuel prices of each area on the basis of the result of inference regarding the fuel prices.

At step S13 in FIG. 6, the cloud-side information processing apparatus can thus present, to the user, the updated information, that is, the information regarding the fuel prices of each area updated using the user terminal 2.

Note that, whereas the inference process is performed using a camera 3 as a vehicle-mounted camera in the example explained here, the inference process may be performed using a camera 3 as a smartphone carried by a human.

For example, according to the purpose of a user who wants to recognize the flowering condition of cherry blossoms of each area, at a park or the like, the processes mentioned above are performed with a smartphone (camera 3), on which a camera application has been activated, as a target. Accordingly, an AI model that can infer the types of trees, an AI model that can detect flowers blooming on the trees, an AI model that can infer a flowering rate (full bloom rate) from results of the inference, and the like are deployed on the camera 3 as a smartphone as appropriate. Then, the camera 3 executes a process of uploading estimated flowering rate information to the cloud-side information processing apparatus.

Accordingly, the cloud-side information processing apparatus can update information regarding the flowering condition of cherry blossoms of each area, and it becomes possible for the cloud-side information processing apparatus to present the information to the user.

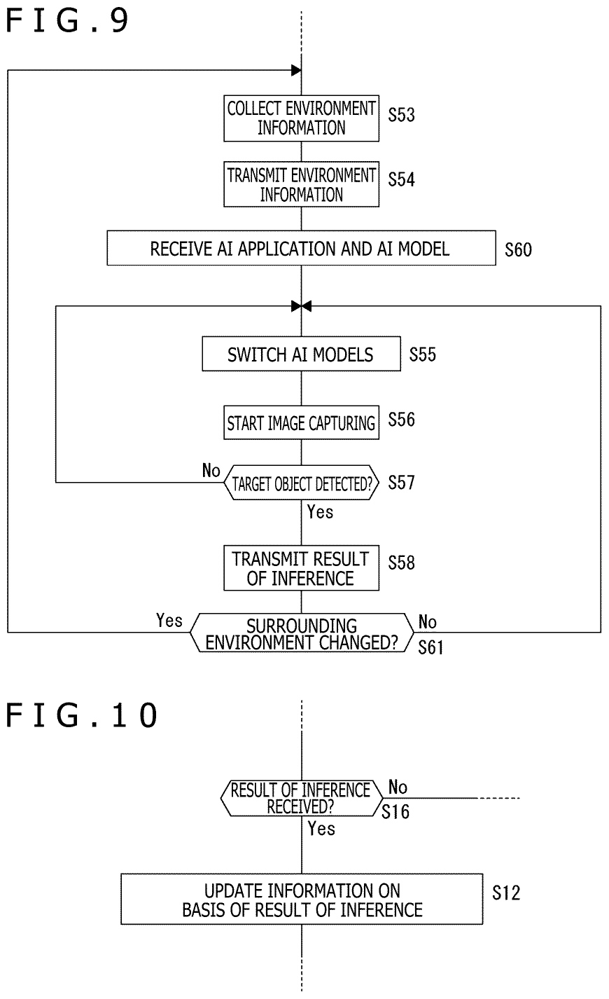

Next, an example of processes executed by the computation processing section of the camera 3 and the computation processing section of the cloud-side information processing apparatus in order to achieve multiple purposes is explained with reference to FIG. 9 and FIG. 10.

FIG. 9 is a flowchart regarding processes executed by the computation processing section of the camera 3. Note that the respective processes depicted in FIG. 9 are some of processes executed by the computation processing section of the camera 3 after the process at step S53 in FIG. 5, processes executed before step S53 are similar to those in FIG. 5, and accordingly, explanations thereof are omitted.

The camera 3 collects environment information at step S53 and transmits the environment information at step S54.

At step S60, the camera 3 receives an AI application and an AI model from the cloud-side information processing apparatus. For example, the AI application and the AI model received here are ones selected in a case where the purpose is to recognize the traffic jam condition.

The camera 3 performs switching of AI models at step S55 and starts image capturing at step S56. An inference process for recognizing the traffic jam condition is performed regarding captured images thus obtained.

Specifically, at step S57, the camera 3 determines whether or not a target object has been detected. For example, target objects to be detected here include other vehicles around the vehicle, or the like.

In a case where it is determined that a target object has not been detected, the camera 3 returns to the process at step S55.

On the other hand, in a case where it is determined that a target object has been detected, the camera 3 performs an inference process and thereafter transmits a result of inference to the cloud-side information processing apparatus at step S58.

Here, in the inference process, the camera 3 may use movement speeds of vehicles (including both the subject vehicle and other vehicles) and the like. In addition, the traffic jam condition of an oncoming lane may be inferred by detecting other vehicles traveling on the oncoming lane.

After the process of transmitting at step S58, at step S61, the camera 3 determines whether or not the surrounding environment has changed. In a case where it is determined that the surrounding environment has changed, the camera 3 returns to step S53 and repeats the procedure from the process of collecting environment information.

On the other hand, in a case where it is determined that the surrounding environment has not changed, the camera 3 returns to the process at step S55. Then, in the process at step S55, the process of switching AI applications and AI models is performed. By this process, the camera 3 makes a switch from a mode in which target objects such as nearby vehicles are detected on captured images and an inference process regarding the traffic jam condition is performed to a mode in which target objects such as accident-involved vehicles are detected and an inference process regarding the accident situation is performed.

That is, the camera 3 starts image capturing at step S56, determines whether or not an accident-involved vehicle or the like as a target object has been detected at step S57, and transmits, to the cloud-side information processing apparatus, a result of inference as a result of detection of an accident-involved vehicle or the like at step S58.

For example, such switching of AI applications and AI models may be performed every time an image is captured or may be performed at predetermined time intervals such as one-second periods.

In addition, by performing such switching, the inference process for achieving the purpose to recognize the traffic jam condition and the inference process for achieving the purpose to recognize the accident situation can be executed in a time division manner.

FIG. 10 depicts processes executed by the computation processing section of the cloud-side information processing apparatus at this time. Note that the respective processes depicted in FIG. 10 are only some of processes executed by the computation processing section of the cloud-side information processing apparatus after the process at step S16 in FIG. 6, other processes are similar to those in FIG. 6, and accordingly, explanations thereof are omitted.

At step S16, the cloud-side information processing apparatus determines whether or not a result of inference has been received. In a case where it is determined that a result of inference has been received, at step S12, the cloud-side information processing apparatus updates various types of information on the basis of the received result of inference.

That is, in a case where the camera 3 performs the inference process for achieving the purpose to recognize the traffic jam condition, a result of inference for recognizing the traffic jam condition is received, and information regarding the traffic jam condition is updated. In addition, in a case where the camera 3 performs the inference process for achieving the purpose to recognize the accident situation, a result of inference for recognizing the accident situation is received, and information regarding the accident situation is updated.

In this manner, it is possible to cause inference processes for achieving multiple purposes to be performed using one camera 3.

### <4. Function Overview of System>

In the present embodiment, assumed as a service using the information processing system 100 is a service that allows a user as a customer to select the types of functions of AI image processing by each camera 3. The selection of the types of functions can also be said differently as setting of purposes mentioned above. In addition, for example, an image recognition function, an image detection function, and the like may be selected, or more specific types may be selected such that an image recognition function or an image detection function regarding a particular subject is enabled.

For example, in one business model, a service provider sells cameras 3 and fog servers 4 having AI-enabled image recognition functions to users, and causes the users to install the cameras 3 and the fog servers 4 inside vehicles or at monitoring-target locations. Then, a service to provide analysis information like the one mentioned above to users is rolled out.

At this time, since different customers have different uses (purposes) such as recognizing a traffic jam condition, recognizing an accident situation, or recognizing fuel prices of each area, or a use for store monitoring, a use for traffic monitoring, or the like, for which they demand to use the system, it is made possible to selectively set AI image processing functions of cameras 3 such that analysis information corresponding to the uses demanded by the customers can be obtained.

In addition, it is also possible that information that is desired to be acquired using a camera 3 changes when a disaster such as an earthquake occurs. Specifically, AI image processing functions of cameras 3 as vehicle-mounted cameras for recognizing the traffic jam condition are enabled in a normal state, and, at the time of a disaster, AI image processing functions of cameras 3 as vehicle-mounted cameras of vehicles traveling in an area where the disaster has occurred are switched such that recognition results regarding the road surface condition can be obtained. At that time, it is also possible that AI models are changed such that more appropriate recognition results can be obtained.

In the present example, the management server 5 has such a function to selectively set AI image processing functions of cameras 3.

Note that the cloud server 1 or the fog server 4 may have functions of the management server 5.

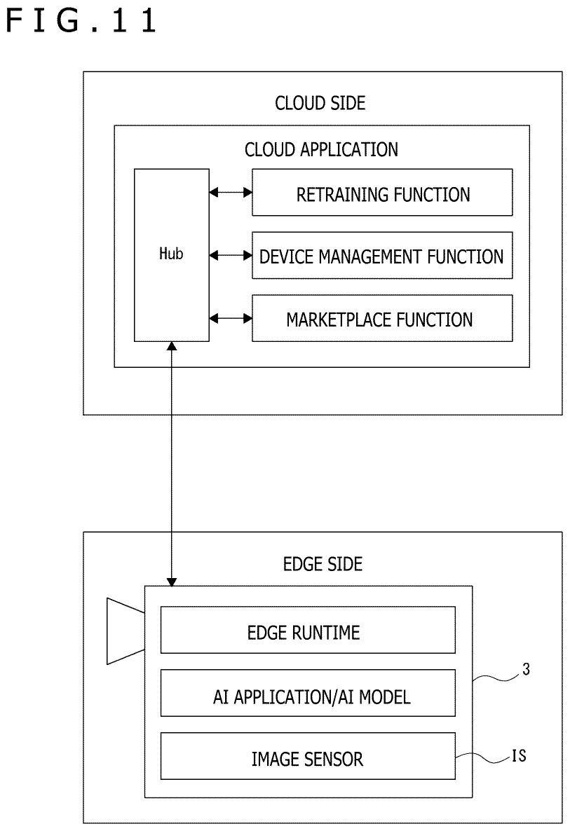

Here, connection between the cloud server 1 or the management server 5 which is a cloud-side information processing apparatus and a camera 3 which is an edge-side information processing apparatus is explained with reference to FIG. 11.

A retraining function, a device management function, and a marketplace function which are functions that can be used via a Hub are implemented on the cloud-side information processing apparatus.

The Hub performs highly reliable security-protected communication with the edge-side information processing apparatus. Accordingly, the Hub can provide various functions to the edge-side information processing apparatus.

The retraining function is a function to perform retraining and provide newly optimized AI models, and, by using this function, appropriate AI models based on new training materials are provided.

The device management function is a function to manage cameras 3 and the like as edge-side information processing apparatuses, and, for example, can provide functions to manage and monitor AI models deployed on the cameras 3, detect and troubleshoot problems, and so on.

In addition, the device management function is also a function to manage information regarding cameras 3 and fog servers 4. The information regarding cameras 3 and fog servers 4 includes information regarding chips used as computation processing sections, information regarding memory capacities and storage capacities as well as usage rates of CPUs and memories and the like, information regarding software such as an OS (Operating System) installed on each apparatus, and the like.

Further, the device management function protects secure access by authenticated users.

The marketplace function provides a function to register AI models developed by AI model developers and AI applications developed by application developers mentioned above, a function to deploy the developed items on permitted edge-side information processing apparatuses, or the like. In addition, the marketplace function also provides a function related to payment of incentives according to the deployment of developed items.

A camera 3 as an edge-side information processing apparatus includes an edge runtime, an AI application, an AI model, and an image sensor IS.

The edge runtime functions as embedded software for managing applications deployed on the camera 3 and communicating with the cloud-side information processing apparatus, and the like.

As mentioned before, the AI model is a deployed AI model registered in the marketplace of the cloud-side information processing apparatus, and, by using the AI model, the camera 3 can obtain information regarding results of AI image processing according to purposes by using captured images.

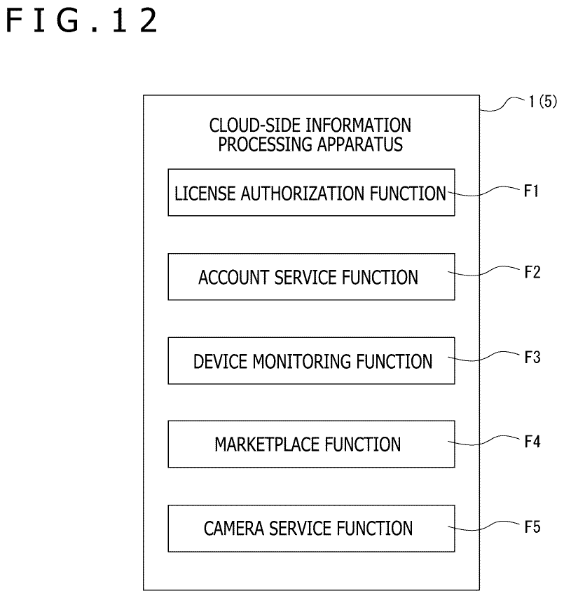

With reference to FIG. 12, an overview of functions of the cloud-side information processing apparatus is explained. Note that the cloud-side information processing apparatus collectively refers to apparatuses such as the cloud server 1 and the management server 5.

As depicted in the figure, the cloud-side information processing apparatus has a license authorization function F1, an account service function F2, a device monitoring function F3, a marketplace function F4, and a camera service function F5.

The license authorization function F1 is a function to perform various authentication-related processes. Specifically, as the license authorization function F1, a process related to device authentication of each camera 3 and a process related to authentication of each of AI models, software, and firmware used at the camera 3 are performed.

Here, the software described above means software that is necessary for appropriately realizing AI image processing at the camera 3.

In order for AI image processing based on captured images to be performed appropriately and for results of AI image processing to be transmitted to the fog server 4 or the cloud server 1 in an appropriate format, it is required to control data input to an AI model, appropriately process output data of the AI model, and so on. The software described above is software including peripheral processes that are necessary for appropriately realizing AI image processing. Such software is software for realizing desired functions by using an AI model and corresponds to the AI application mentioned above.

Note that an AI application does not necessarily use only one AI model and may use two or more AI models. For example, there can also be an AI application that has a processing procedure in which information (image data and the like; hereinafter, referred to as “recognition result information”) regarding recognition results obtained by an AI model that executes AI image processing using captured images as input data is input to another AI model, and the other AI model is caused to execute second AI image processing.

The license authorization function F1 performs a process of issuing a device ID (Identification) for each camera 3 in a case where connection is established with cameras 3 via the network 6, for authentication of the cameras 3.

In addition, for authentication of AI models or software, a process of issuing an ID (AI model ID, software ID) unique to each of AI models and AI applications for which the AI model developer terminal 2C or a software developer terminal 7 has made a registration application is performed.

In addition, the license authorization function F1 performs a process of issuing, for manufacturers of cameras 3 (particularly, manufacturers of image sensors IS mentioned later), AI model developers, and software developers, various keys, certificates, and the like for enabling secure communication among the cameras 3, the AI model developer terminal 2C, the software developer terminal 7, and the cloud server 1, and also performs a process for updating or stopping effectiveness of the certificates.

Further, the license authorization function F1 also performs a process of associating a camera 3 (a device ID described above) purchased by a user with a user ID in a case where user registration (account information registration involving issuance of the user ID) is performed using the account service function F2 explained below.

The account service function F2 is a function to generate and manage account information regarding users. The account service function F2 accepts input of user information and generates account information on the basis of the input user information (generates account information including at least user IDs and password information).

In addition, the account service function F2 also performs a registration process (account information registration) regarding AI model developers and AI application developers (hereinafter, called “software developers” for short, in some cases).

Further, the account service function F2 manages AI models and AI applications available for each user in association with account information. For example, available AI models and AI applications are AI models and AI applications for which payment of incentives for a user who performs development mentioned above has been completed.

The device monitoring function F3 is a function to perform a process for monitoring the use statuses of cameras 3. For example, monitoring is performed regarding information such as the usage rates of CPUs or memories mentioned above as various elements related to the use statuses of cameras 3, including use locations of cameras 3, output frequencies of output data of AI image processing, or free capacities of CPUs or memories used for AI image processing.

The marketplace function F4 is a function for selling AI models and AI applications. For example, users are allowed to purchase AI applications and AI models used by the AI applications, via a sales WEB site (sales site) provided by the marketplace function F4. In addition, software developers are allowed to purchase AI models for creating AI applications, via the sales site described above.

The camera service function F5 is a function for providing services related to use of cameras 3 to users.

For example, part of the camera service function F5 includes a function related to generation of analysis information mentioned before. That is, it is a function to perform a process for generating analysis information regarding subjects on the basis of processing result information of image processing at a camera 3 and allowing a user to view the generated analysis information via a user terminal 2.

In addition, the camera service function F5 includes an image capturing setting search function. Specifically, the image capturing setting search function is a function to acquire recognition result information of AI image processing from a camera 3 and search for image capturing setting information of the camera 3 by using AI on the basis of the acquired recognition result information. Here, the image capturing setting information broadly means setting information related to an image capturing operation for obtaining captured images. Specifically, it broadly includes optical settings such as focus or aperture, settings related to an operation of reading out captured-image signals, such as frame rate, exposure time, or gain, settings related to image signal processing on the captured-image signals having been read out such as gamma correction processing, noise reduction processing, or super-resolution processing, and the like.

When the image capturing setting search function functions appropriately, the image capturing settings of a camera 3 are optimized according to a purpose set by a user, and favorable results of inference can be obtained.

In addition, the camera service function F5 also includes an AI model search function. The AI model search function is a function to acquire information regarding recognition results of AI image processing from a camera 3 and, on the basis of the acquired recognition result information and using AI, perform a search for an optimum AI model to be used for AI image processing at the camera 3. For example, the search for an AI model mentioned here means a process of optimizing various process parameters such as weighting factors, setting information (e.g., including information regarding kernel sizes or the like) related to neural network structures, and the like in a case where AI image processing is realized by a CNN (Convolutional Neural Network) or the like including convolutional computation.

In addition, the camera service function F5 has a function to select and deploy an AI application and an AI model on the basis of a set purpose and information related to a sensor and acquired from a camera 3.

For example, the information related to a sensor acquired from a camera 3 includes not only information regarding the type (an RGB sensor, a distance measurement sensor, or the like), the model number, or the like of an image sensor included in the camera 3, but also sensing information acquired by the sensor. Specifically, it is positional information regarding the camera 3 which is sensing information obtained by a GPS (Global Positioning System) function that the camera 3 has, or the like.

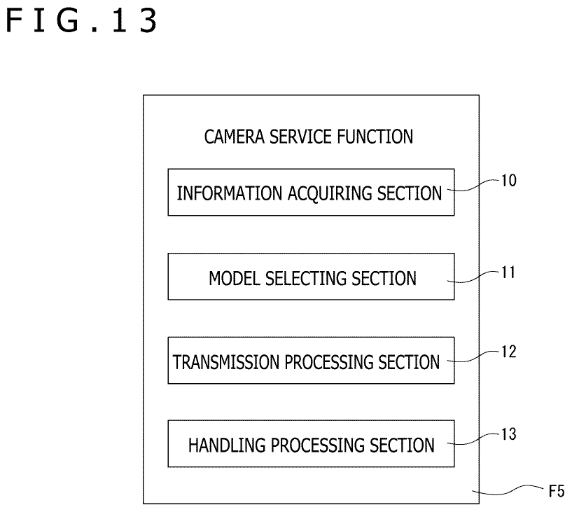

FIG. 13 depicts an example of a configuration of the camera service function F5 for deploying an appropriate AI application and AI model on a camera 3 according to a purpose set by a user.

In order to realize the camera service function F5, the cloud-side information processing apparatus includes an information acquiring section 10, a model selecting section 11, a transmission processing section 12, and a handling processing section 13.

As information related to a sensor, for example, the information acquiring section 10 acquires information related to the model number or type of the sensor and information obtained by sensing, from a camera 3 as an edge-side information processing apparatus.

On the basis of the purpose set by the user and the information related to the sensor and acquired by the information acquiring section 10, the model selecting section 11 selects an AI model to be deployed on the camera 3. Note that, at this time, an AI application optimum for using an AI model may be selected.

The transmission processing section 12 performs a process of deploying, on the camera 3, the AI application and AI model selected by the model selecting section 11. Accordingly, an AI application and an AI model that perform an inference process for detecting particular subjects can be deployed only on a camera 3 as a vehicle-mounted camera installed on a vehicle traveling in a predetermined area.

The handling processing section 13 executes a process of handling by use of results of inference acquired from cameras 3. For example, in a case where information related to the road condition has been acquired from a camera 3, the process of handling is a process of causing the road condition to be reflected in map data, a process of selecting a route considering the road condition in a service of providing route information by using the map data or the like, and so on. In addition, regarding a user who is using a route information provision service, the handling process may be a process of guiding the user with, as a recommended route, a route that is newly selected considering the road condition, and the like. Accordingly, it is possible to cause the user to travel along an appropriate route.

In addition, in a case where information regarding fuel prices of each area has been acquired from an edge-side information processing apparatus, the handling process is a process of updating a database on which fuel prices of each area are stored, a process of presenting the database to a user, and the like.

Note that the camera service function F5 may have a function to decide process allocation. In the process allocation decision function, performed is a process of deciding a deployment destination apparatus for each SW component when an AI application is to be deployed on an edge-side information processing apparatus. Note that some SW components may be decided as being executed at the cloud-side apparatus, and, in this case, the deployment process may not be performed since the SW components have already been deployed on the cloud-side apparatus.

With the image capturing setting search function and the AI model search function like the ones described above, it is attempted to perform image capturing setting to make results of AI image processing favorable, and it is possible to attempt to perform AI image processing by using appropriate AI models according to actual use environments.

Then, in addition to them, further with the process allocation decision function, it is possible to attempt to execute AI image processing and analysis processing therefor at appropriate apparatuses.

Note that the camera service function F5 has an application setting function that is to be executed before deployment of each SW component. The application setting function is a function to set appropriate AI applications according to purposes of users.

For example, an appropriate AI application is selected according to a purpose selected by a user. Accordingly, SW components included in the AI application are naturally decided. Note that, as mentioned later, there may be multiple types of combinations of SW components for realizing the purpose of the user by using an AI application, and, in this case, one combination is selected according to information regarding an edge-side information processing apparatus and a request from the user.

For example, in a case where the purpose of the user is store monitoring, combinations of SW components may be different between a case where the user requests to prioritize privacy and a case where the user requests to prioritize speed.

In the application setting function, performed are a process of accepting operation by a user to select a purpose (application) on a user terminal 2 (corresponding to the application user terminal 2B in FIG. 2), a process of selecting an appropriate AI application according to the selected application, and the like.

Here, whereas the cloud server 1 singly realizes the license authorization function F1, the account service function F2, the device monitoring function F3, the marketplace function F4, and the camera service function F5 in the configuration illustrated in the description above, these functions can be realized by multiple information processing apparatuses in an allocated manner, in another possible configuration. For example, it is possible that each of the functions described above is performed by one information processing apparatus. Alternatively, it is also possible that a single function in the functions described above is performed by multiple information processing apparatuses (e.g., the cloud server 1 and the management server 5) in an allocated manner.

In FIG. 1, the AI model developer terminal 2C is an information processing apparatus used by the AI model developer.

In addition, the software developer terminal 7 is an information processing apparatus used by an AI application developer.

### <5. Configuration of Image Capturing Apparatus>

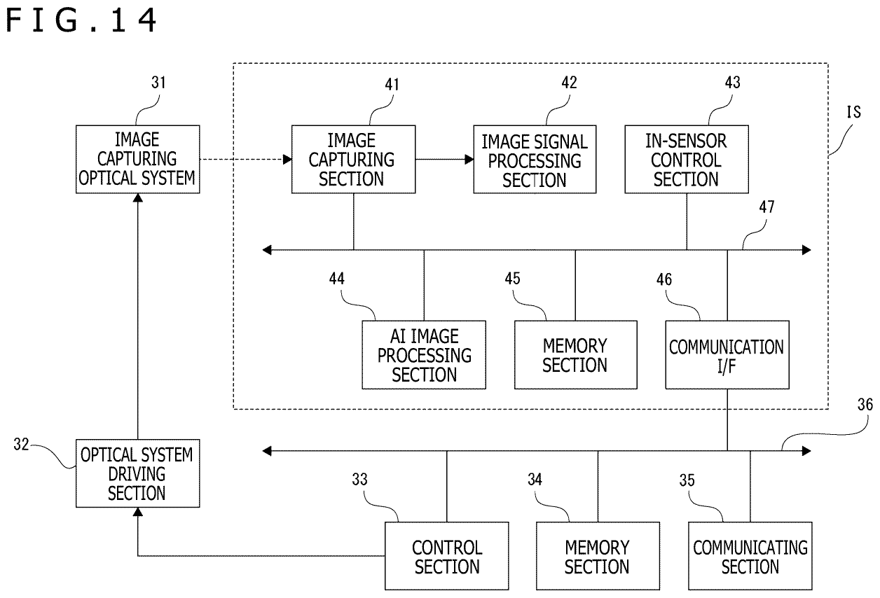

FIG. 14 is a block diagram depicting an internal configuration example of a camera 3.

As depicted in the figure, the camera 3 includes an image capturing optical system 31, an optical system driving section 32, the image sensor IS, a control section 33, a memory section 34, and a communicating section 35. The image sensor IS, the control section 33, the memory section 34, and the communicating section 35 are connected to one another via a bus 36, and they are allowed to perform data communication mutually.

The image capturing optical system 31 includes lenses such as a cover lens, a zoom lens, or a focus lens and an aperture (iris) mechanism. The image capturing optical system 31 guides light (incident light) from a subject and concentrates the light on a light reception surface of the image sensor IS.

The optical system driving section 32 comprehensively represents a driving section of the zoom lens, the focus lens, and the aperture mechanism of the image capturing optical system 31. Specifically, the optical system driving section 32 has respective actuators for driving the zoom lens, the focus lens, and the aperture mechanism as well as a drive circuit for the actuators.

For example, the control section 33 includes a microcomputer having a CPU, a ROM, and a RAM and performs overall control of the camera 3 by causing the CPU to execute various processes in accordance with programs stored on the ROM or programs loaded onto the RAM.

In addition, the control section 33 gives the optical system driving section 32 drive instructions regarding the zoom lens, the focus lens, the aperture mechanism, and the like. In response to the drive instructions, the optical system driving section 32 causes the focus lens or the zoom lens to move, open or close aperture blades of the aperture mechanism, and so on.

In addition, the control section 33 performs control regarding writing and reading of various types of data to and from the memory section 34.

For example, the memory section 34 is a non-volatile storage device such as an HDD (Hard Disk Drive) or a flash memory device and is used as a storage location (recording location) of image data output from the image sensor IS.

Further, the control section 33 performs various types of data communication with an external apparatus via the communicating section 35. The communicating section 35 in the present example is capable of data communication at least with the fog server 4 (or the cloud server 1) depicted in FIG. 1.

For example, the image sensor IS is configured as an image sensor of a CCD type, a CMOS type, or another type.

The image sensor IS includes an image capturing section 41, an image signal processing section 42, an in-sensor control section 43, an AI image processing section 44, a memory section 45, and a communication I/F 46, and they are allowed to perform data communication mutually via a bus 47.

The image capturing section 41 includes a pixel array section in which pixels having photoelectric converting elements such as photodiodes are arrayed two-dimensionally, and a read circuit that reads out electric signals obtained by photoelectric conversion from respective pixels included in the pixel array section, and the image capturing section 41 is capable of outputting the electric signals as captured-image signals.

In the read circuit, for example, a CDS (Correlated Double Sampling) process, an AGC (Automatic Gain Control) process, and the like are executed on electric signals obtained by photoelectric conversion, and further an A/D (Analog/Digital) conversion process is performed.

The image signal processing section 42 performs preprocessing, synchronization processing, YC generation processing, resolution conversion processing, codec processing, and the like on captured-image signals as digital data obtained after the A/D conversion process.

In the preprocessing, a clamping process of clamping R, G, and B black levels of captured-image signals at a predetermined level, a correction process among R, G, and B color channels, and the like are performed. In the synchronization processing, a color separation process to make image data of respective pixels have color components of all of R, G, and B is implemented. For example, in the case of image capturing elements using Bayer-array color filters, a demosaicing process is performed as the color separation process. In the YC generation processing, brightness (Y) signals and color (C) signals are generated (separated) from R, G, and B image data. In the resolution conversion processing, resolution conversion processing is executed on image data having been subjected to various types of signal processing.

In the codec processing, for example, an encoding process and file generation for recording and communication are performed on the image data having been subjected to the various processes described above. In the codec processing, for example, it is possible to perform generation of files in formats such as MPEG-2 (MPEG: Moving Picture Experts Group) or H.264 as video file formats. In addition, it is also possible that generation of files in formats such as JPEG (Joint Photographic Experts Group), TIFF (Tagged Image File Format), or GIF (Graphics Interchange Format) as still image files is performed. Note that, in a case where the image sensor IS is a distance measurement sensor, for example, the image signal processing section 42 calculates distance information regarding a subject on the basis of two signals output from the image sensor IS as iToF (indirect Time of Flight) and outputs a distance image.

The in-sensor control section 43 performs control to execute an image capturing operation by giving an instruction to the image capturing section 41. Similarly, the in-sensor control section 43 performs control to cause the image signal processing section 42 to execute processes.

The AI image processing section 44 performs an image recognition process as AI image processing on captured images.

For example, an image recognition function using AI can be realized using a programmable computation processing apparatus such as a CPU, an FPGA (Field Programmable Gate Array), or a DSP (Digital Signal Processor).

It is possible to perform switching of functions of image recognition that can be realized with the AI image processing section 44, by changing the algorithm of AI image processing. Stated differently, by switching the AI model used for AI image processing, the function type of AI image processing can be switched. There is a variety of function types of AI image processing, and, for example, examples thereof include types illustrated below.
Class identification
Semantic segmentation
Human detection
Vehicle detection
Target tracking
OCR (Optical Character Recognition)

Class identification in the function types described above is a function to identify a class of a target. The class mentioned here is information representing the category of an object and, for example, is one that makes distinction between “human,” “automobile,” “airplane,” “ship,” “truck,” “bird,” “cat,” “dog,” “deer,” “frog,” “horse,” and the like.

Target tracking is a function to track a subject designated as a target, in other words, a function to obtain history information regarding the position of the subject.

Switching of AI models may be performed in response to an instruction from the cloud-side information processing apparatus or may be performed on the basis of a determination process performed by the control section 33 or the in-sensor control section 43 of the camera 3. In addition, when switching of AI models is to be performed, the AI model may be switched to any one of multiple AI models stored on the memory section 45 or may be switched to an AI model received from the cloud-side information processing apparatus and deployed. By receiving an AI model from the cloud-side information processing apparatus for every switching, required capacity of the memory section 45 can be reduced, and it is possible to attain size reduction, power conservation, and cost reduction.

The memory section 45 is used as a storage location of various types of data such as captured image data obtained by the image signal processing section 42. In addition, in the present example, it is possible to use the memory section 45 also for temporary storage of data to be used by the AI image processing section 44 in the course of AI image processing.

In addition, information regarding AI applications and AI models to be used by the AI image processing section 44 is stored on the memory section 45.

Note that the information regarding AI applications and AI models may be deployed on the memory section 45 as containers or the like, by using a container technology mentioned later, or may be deployed by using a microservice technology. By deploying an AI model to be used for AI image processing on the memory section 45, it is possible to change the function type of AI image processing or to change an AI model into an AI model improved in performance by retraining, and so on.

Note that, whereas, in the present embodiment as mentioned above, an explanation is given on the basis of an example regarding AI models and AI applications to be used for image recognition, this is not the sole example. Programs or the like to be executed using an AI technology may be targeted.

In addition, in a case where the capacity of the memory section 45 is small, the information regarding AI applications and AI models may be deployed on a memory outside the image sensor IS such as the memory section 34 as containers or the like by use of a container technology, and thereafter only the AI models may be stored on the memory section 45 in the image sensor IS via the communication I/F 46 explained in the description below.

The communication I/F 46 is an interface that communicates with the control section 33, the memory section 34, and the like located outside the image sensor IS. The communication I/F 46 performs communication for externally acquiring programs to be executed by the image signal processing section 42 as well as AI applications, AI models, and the like to be used by the AI image processing section 44, and causes them to be stored on the memory section 45 included in the image sensor IS.

Accordingly, the AI models are stored on part of the memory section 45 included in the image sensor IS, and it becomes possible for the AI image processing section 44 to use them.

By performing a predetermined image recognition process using the AI applications and AI models thus obtained, the AI image processing section 44 recognizes subjects according to purposes.

Recognition result information of AI image processing is output to the outside of the image sensor IS via the communication I/F 46.

That is, not only image data output from the image signal processing section 42 but also recognition result information of AI image processing is output from the communication I/F 46 of the image sensor IS.

Note that it is also possible to cause only either image data or recognition result information to be output from the communication I/F 46 of the image sensor IS.

For example, in a case where the AI model retraining function mentioned above is to be used, captured image data to be used for the retraining function is uploaded from the image sensor IS to the cloud-side information processing apparatus via the communication I/F 46 and the communicating section 35.

In addition, in a case where inference using an AI model is to be performed, recognition result information of AI image processing is output from the image sensor IS to another information processing apparatus outside the camera 3 via the communication I/F 46 and the communicating section 35.

There are various possible configurations of the image sensor IS. In an example explained here, the image sensor IS includes a dual-layered structure.

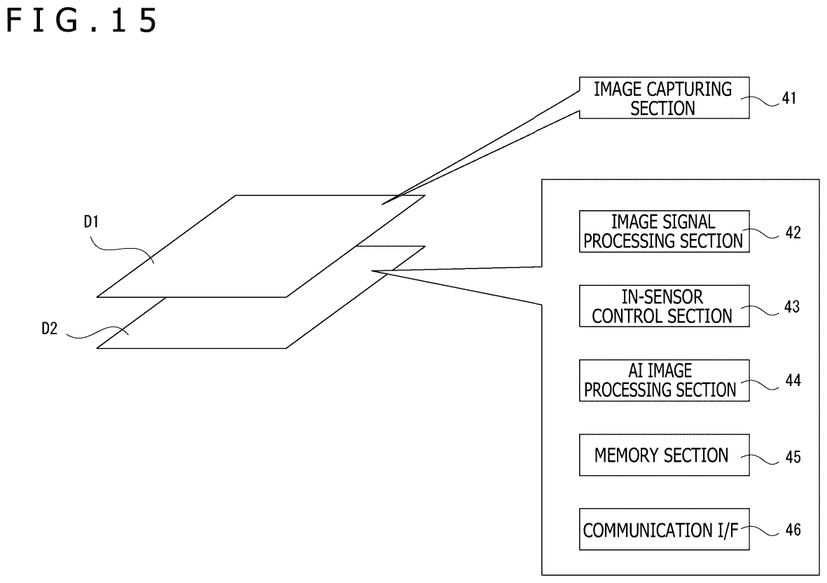

As depicted in FIG. 15, the image sensor IS is configured as a one-chip semiconductor device in which two dies are stacked one on another.

The image sensor IS is configured by stacking, one on another, a die D1 having a function as the image capturing section 41 depicted in FIG. 14 and a die D2 including the image signal processing section 42, the in-sensor control section 43, the AI image processing section 44, the memory section 45, and the communication I/F 46.

For example, the die D1 and the die D2 are electrically connected to each other by Cu-Cu junction.

There are various possible methods of deploying AI models, AI applications, and the like on the camera 3. As an example, an example using a container technology is explained.

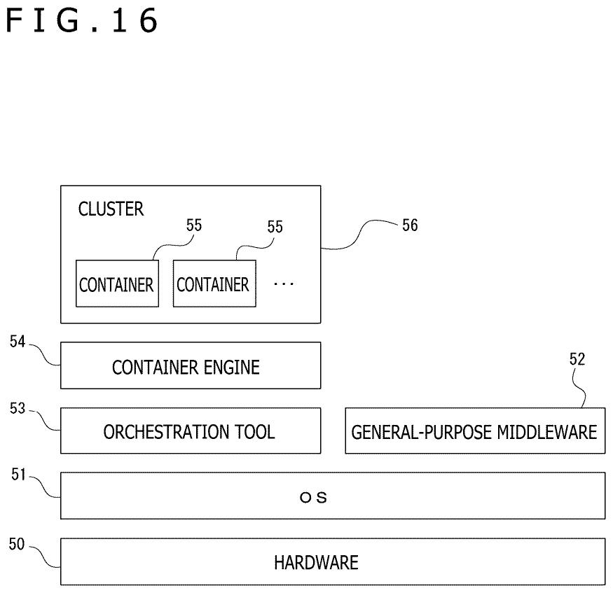

In the camera 3, an operation system 51 is installed on various types of hardware 50 such as a CPU and a GPU (Graphics Processing Unit) as the control section 33 depicted in FIG. 14, a ROM, and a RAM (see FIG. 16).

The operation system 51 is basic software that performs overall control of the camera 3 in order to realize various functions of the camera 3.

General-purpose middleware 52 is installed on the operation system 51.

For example, the general-purpose middleware 52 is software for realizing basic operations such as a communication function using the communicating section 35 as the hardware 50 or a display function using a display section (a monitor, etc.) as the hardware 50.

Not only the general-purpose middleware 52 but also an orchestration tool 53 and a container engine 54 are installed on the operation system 51.

The orchestration tool 53 and the container engine 54 deploy and execute containers 55 by building a cluster 56 as an operating environment for the containers 55.

Note that the edge runtime depicted in FIG. 11 corresponds to the orchestration tool 53 and the container engine 54 depicted in FIG. 16.

The orchestration tool 53 has a function for causing the container engine 54 to appropriately allocate resources of the hardware 50 and the operation system 51 mentioned above. The orchestration tool 53 groups the respective containers 55 into predetermined units (pods mentioned later), and the respective pods are deployed on worker nodes (mentioned later) which are defined as logically different areas.

The container engine 54 is one of components of middleware installed on the operation system 51 and is an engine for operating the containers 55. Specifically, the container engine 54 has a function to allocate, to the containers 55, resources (memory, computation capability, etc.) of the hardware 50 and the operation system 51 on the basis of setting files included in middleware in the containers 55 or the like.

In addition, resources allocated in the present embodiment include not only resources such as the control section 33 included in the camera 3 but also resources such as the in-sensor control section 43, the memory section 45, or the communication I/F 46 included in the image sensor IS.

The containers 55 include applications for realizing predetermined functions and middleware such as libraries.

The containers 55 operate to realize predetermined functions using resources of the hardware 50 and the operation system 51 allocated by the container engine 54.

In the present embodiment, the AI application and the AI model depicted in FIG. 11 correspond to one of the containers 55. That is, one of the various containers 55 deployed on the camera 3 realizes a predetermined AI image processing function using the AI application and the AI model.

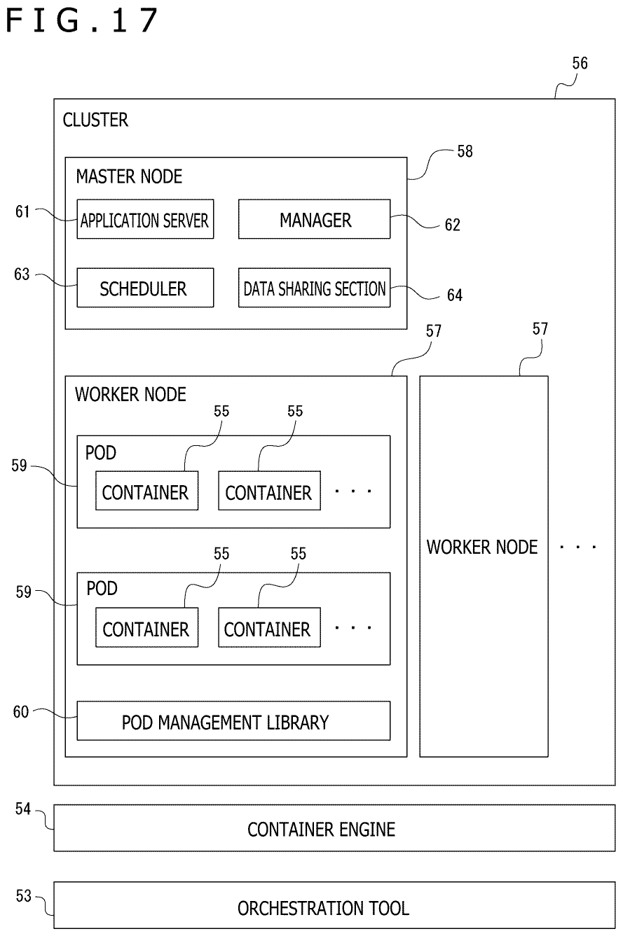

A specific configuration example of the cluster 56 built by the container engine 54 and the orchestration tool 53 is explained with reference to FIG. 17. Note that the cluster 56 may be built not only by the hardware 50 included in one camera 3 but also by multiple pieces of equipment such that a function is realized by using resources of other hardware included in another apparatus.

The orchestration tool 53 performs management of execution environments of the containers 55 for each worker node 57. In addition, the orchestration tool 53 builds a master node 58 that manages the whole of the worker nodes 57.

Multiple pods 59 are deployed on each worker node 57. A pod 59 includes one or more containers 55 and realizes a predetermined function. The pods 59 are management units for management of the containers 55 by the orchestration tool 53.

Operations of the pods 59 at each worker node 57 are controlled by a pod management library 60.

The pod management library 60 has a container runtime for causing the pods 59 to use logically allocated resources of the hardware 50, an agent that accepts control from the master node 58, a network proxy that performs communication between the pods 59 and communication with the master node 58, and the like.

That is, the pod management library 60 makes it made possible for each pod 59 to realize a predetermined function using each resource.

The master node 58 includes an application server 61 that deploys the pods 59, a manager 62 that manages the status of deployment of the containers 55 by the application server 61, a scheduler 63 that decides the worker nodes 57 where the containers 55 are arranged, and a data sharing section 64 that performs data sharing.

By using the configurations depicted in FIG. 16 and FIG. 17, it becomes possible to deploy AI applications and AI models mentioned before, by using a container technology on the image sensor IS of the camera 3.

Note that, as mentioned before, AI models may be stored on the memory section 45 in the image sensor IS via the communication I/F 46 in FIG. 14 to execute AI image processing in the image sensor IS, or the configurations depicted in FIG. 16 and FIG. 17 may be deployed on the memory section 45 and the in-sensor control section 43 in the image sensor IS to execute AI applications and AI models mentioned before, by using a container technology in the image sensor IS.

In addition, as mentioned later, even in a case where AI applications and/or AI models are deployed on the fog server 4 or the cloud-side information processing apparatus, a container technology can be used.

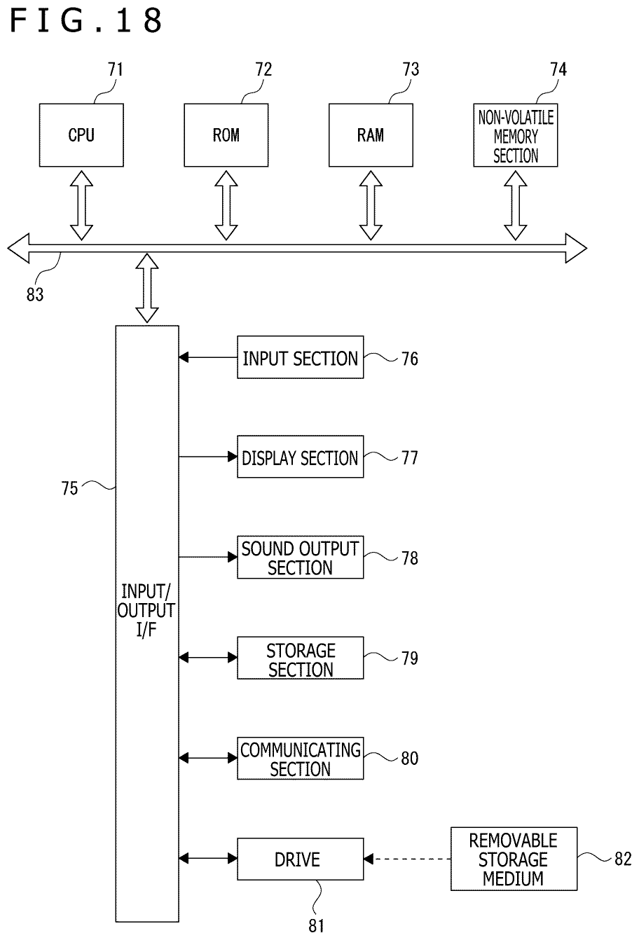

At that time, as containers or the like, information regarding AI applications and AI models is deployed and executed on a memory such as a non-volatile memory section 74, a storage section 79, or a RAM 73 in FIG. 18 mentioned later.

### <6. Hardware Configuration of Information Processing Apparatus>

A hardware configuration of an information processing apparatus such as the cloud server 1, the user terminals 2, the fog server 4, or the management server 5 included in the information processing system 100 is explained with reference to FIG. 18.

The information processing apparatus includes a CPU 71. The CPU 71 functions as a computation processing section that performs various processes mentioned above and executes various processes in accordance with programs stored on a ROM 72 or the non-volatile memory section 74 such as, for example, an EEP-ROM (Electrically Erasable Programmable Read-Only Memory) or programs loaded from the storage section 79 onto the RAM 73. Also, data necessary for execution of the various processes by the CPU 71 or the like also is stored as appropriate on the RAM 73.

Note that the CPU 71 included in the information processing apparatus as the cloud server 1 functions as a license authorizing section, an account service providing section, a device monitoring section, a marketplace function providing section, and a camera service providing section in order to realize the respective functions mentioned above.

The CPU 71, the ROM 72, the RAM 73, and the non-volatile memory section 74 are interconnected via a bus 83. The bus 83 also is connected with an input/output interface (I/F) 75.

The input/output interface 75 is connected with an input section 76 including a control element or an operation device.

For example, the input section 76 is assumed to be any one of various control elements or operation devices such as a keyboard, a mouse, a key, a dial, a touch panel, a touch pad, or a remote controller.

User operation is detected by the input section 76, and a signal according to the input operation is interpreted by the CPU 71.

In addition, the input/output interface 75 is connected with, as integrated or separate bodies, a display section 77 including an LCD, an organic EL panel, or the like and a sound output section 78 including a speaker or the like.

The display section 77 is a display section that performs various types of displaying, and includes, for example, a display device provided to a housing of a computer apparatus, a separate display device connected to the computer apparatus, or the like.

The display section 77 executes displaying of images for various types of image processing, processing-target videos, and the like on a display screen on the basis of instructions of the CPU 71. In addition, the display section 77 displays various operation menus, icons, messages, or the like, that is, performs displaying as a GUI (Graphical User Interface), on the basis of instructions of the CPU 71.

The input/output interface 75 is connected with the storage section 79 including a hard disk, a solid memory, or the like and a communicating section 80 including a modem or the like, in some cases.

The communicating section 80 performs a communication process via a transfer path such as the Internet, wired/wireless communication with various types of equipment, and communication by bus communication or the like.

The input/output interface 75 is also connected with a drive 81 as necessary, and a removable storage medium 82 such as a magnetic disc, an optical disc, a magneto-optical disc, or a semiconductor memory is attached to the drive 81 as appropriate.

The drive 81 makes it possible to read out, from the removable storage medium 82, data files of programs or the like to be used for respective processes and the like. The data files having been read out are stored on the storage section 79, images or sounds included in the data files are output at the display section 77 or the sound output section 78, and so on. In addition, computer programs or the like having been read out from the removable storage medium 82 are installed on the storage section 79 as necessary.

On the computer apparatus, for example, software for processes of the present embodiment can be installed via network communication by the communicating section 80 or via the removable storage medium 82. Alternatively, the software may be stored in advance on the ROM 72, the storage section 79, or the like.

In addition, captured images captured with the camera 3 or processing results of AI image processing may be received and stored on the storage section 79 or the removable storage medium 82 via the drive 81.

By the CPU 71 performing processing operations on the basis of various programs, information processing or communication processing necessary as the cloud server 1 which is the information processing apparatus including the computation processing section mentioned above is executed.

Note that the cloud server 1 is not necessarily configured using singly a computer apparatus like the one depicted in FIG. 18, and may be configured by systemization of multiple computer apparatuses. The multiple computer apparatuses may be systemized by a LAN (Local Area Network) or the like or may be arranged remotely using a VPN (Virtual Private Network) or the like using the Internet or the like. The multiple computer apparatuses may include a computer apparatus as a server group (cloud) that can be used by a cloud computing service.

### <7. Others>

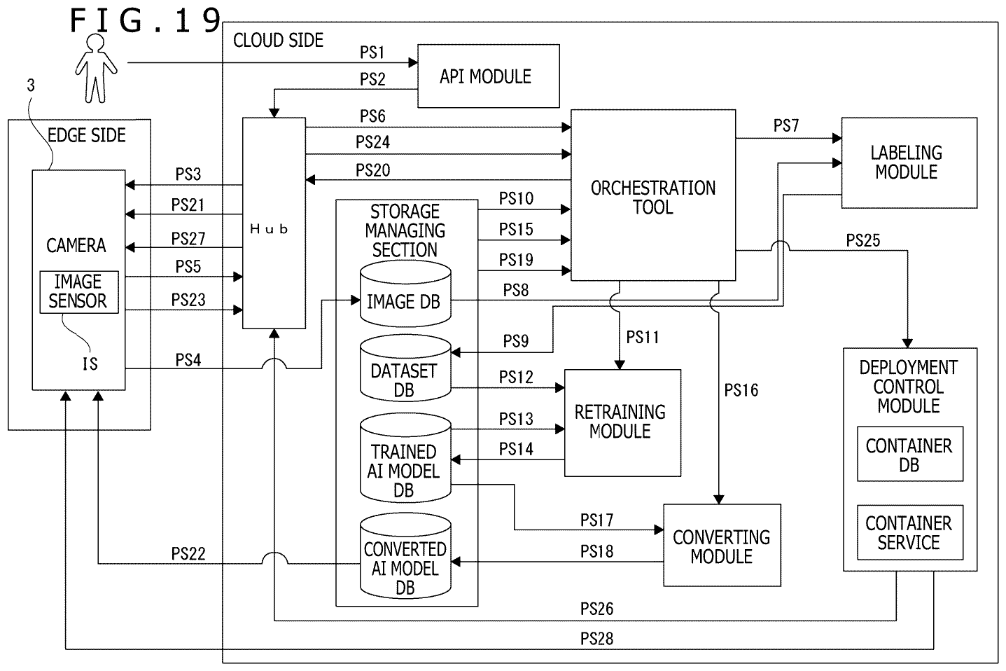

Specifically explained with reference to FIG. 24 is a processing procedure to be performed when, after SW components of an AI application and an AI model are deployed as mentioned above, the AI model is retrained and the AI model (hereinafter, referred to as the “edge-side AI model”) or the AI application deployed on each camera 3 or the like is updated, in response to, as a trigger, operation by a service provider or a user. Note that FIG. 19 is drawn focusing on one camera 3 in the multiple cameras 3. In addition, whereas, as an example, an edge-side AI model corresponding to an update target in the following explanation is one that is deployed on the image sensor IS included in the camera 3, needless to say, the edge-side AI model may be one that is deployed outside the image sensor IS of the camera 3.

First, at processing step PS1, an AI model retraining instruction from a service provider or a user is given. This instruction is given using an API (Application Programming Interface) function of an API module included in a cloud-side information processing apparatus. In addition, the instruction designates the amount of images (e.g., the number of images) to be used for training. Hereinafter, the amount of images to be used for training is referred to also as a “predetermined number of images.”

Upon receiving the instruction, at processing step PS2, the API module transmits a request for retraining, and information regarding the amount of images to a Hub (similar to the one depicted in FIG. 11).

At processing step PS3, the Hub transmits an update notification and the information regarding the amount of images to the camera 3 as an edge-side information processing apparatus.

At processing step PS4, the camera 3 transmits captured image data obtained by performing image capturing to an image DB (Database) of a storage group. The image capturing process and the transmission process are performed until the predetermined number of images necessary for the retraining is reached.

Note that, in a case where the camera 3 has obtained results of inference by performing an inference process on the captured image data, at processing step PS4, the camera 3 may store, on the image DB, the results of inference as metadata of the captured image data.

Since the results of inference at the camera 3 are stored as metadata on the image DB, it is possible to carefully select data necessary for the retraining of the AI model to be executed on the cloud side. Specifically, the retraining can be performed using only image data for which results of inference at the camera 3 and results of inference executed using abundant computer resources at the cloud-side information processing apparatus are different. Accordingly, it becomes possible to shorten the time required for the retraining.

After the image capturing and transmission of the predetermined number of images are finished, at processing step PS5, the camera 3 notifies the Hub that the transmission of data of the predetermined number of captured images has been completed.

Upon receiving the notification, at processing step PS6, the Hub notifies an orchestration tool that preparation of data for the retraining has been completed.

At processing step PS7, the orchestration tool transmits an instruction for executing a labeling process to a labeling module.

The labeling module acquires, from the image DB, target image data of the labeling process (processing step PS8) and performs the labeling process.

The labeling process mentioned here may be a process of performing the class identification mentioned above, may be a process of estimating the gender or age of a subject in an image and giving a label, may be a process of estimating a pose which a subject is in and giving a label, or may be a process of estimating a behavior of a subject and giving a label.

The labeling process may be performed manually or may be performed automatically. In addition, the labeling process may conclude on the cloud-side information processing apparatus or may be realized using a service provided by another server apparatus.

At processing step PS9, the labeling module having finished the labeling process stores, on a dataset DB, information regarding results of the labelling. The information stored on the dataset DB here may be a set of labelled information and image data or may be image ID (Identification) information for identifying image data, instead of the image data itself.

At processing step PS10, a storage managing section having detected that the information regarding results of the labelling has been stored issues a notification to the orchestration tool.

The orchestration tool having received the notification confirms that the labeling process for the data of the predetermined number of images has been ended, and, at processing step PS11, transmits a retraining instruction to a retraining module.

At processing step PS12, the retraining module having received the retraining instruction acquires datasets to be used for training from the dataset DB, and, at processing step PS13, acquires an update-target AI model from a trained AI model DB.

The retraining module performs retraining of the AI model by using the acquired datasets and AI model. At processing step PS14, the updated AI model thus obtained is stored on the trained AI model DB again.

At processing step PS15, the storage managing section having detected that the updated AI model has been stored issues a notification to the orchestration tool.

At processing step PS16, the orchestration tool having received the notification transmits an AI model conversion instruction to a converting module.

At processing step PS17, the converting module having received the conversion instruction acquires the updated AI model from the trained AI model DB and performs an AI model conversion process.

In the conversion process, a process of conversion according to specification information or the like regarding the camera 3 which is deployment destination equipment is performed. In this process, downsizing is performed while avoiding lowering of the performance of the AI model as much as possible, and conversion of the file format or the like is performed such that the AI model can operate on the camera 3.

The converting module makes the converted AI model the edge-side AI model mentioned above. At processing step PS18, the converted AI model is stored on a converted AI model DB.

At processing step PS19, the storage managing section having detected that the converted AI model has been stored issues a notification to the orchestration tool.

At processing step PS20, the orchestration tool having received the notification transmits a notification for causing execution of updating of the AI model to the Hub. This notification includes information for identifying a location where the AI model to be used for the updating is stored.

The Hub having received the notification transmits an AI model update instruction to the camera 3. The update instruction also includes information for identifying the location where the AI model is stored.

At processing step PS22, the camera 3 performs a process of acquiring and deploying the target converted AI model from the converted AI model DB. The AI model used at the image sensor IS of the camera 3 is thus updated.

At processing step PS23, the camera 3 for which the updating of the AI model has been finished with the deployment of the AI model transmits an update completion notification to the Hub.

At processing step PS24, the Hub having received the notification notifies the orchestration tool that the AI model updating process of the camera 3 has been completed.

Note that, whereas the AI model is deployed on and used in the image sensor IS of the camera 3 (e.g., in the memory section 45 depicted in FIG. 14) in the example explained here, the AI model can be updated similarly even in a case where the AI model is deployed and used outside the image sensor but in the camera 3 (e.g., in the memory section 34 in FIG. 14) or in a storage section in the fog server 4.

In that case, an apparatus (location) where the AI model is deployed is stored in advance on a cloud-side storage managing section or the like when the AI model is deployed, and the Hub reads out, from the storage managing section, the apparatus (location) where the AI model is deployed, and transmits an AI model update instruction to the apparatus where the AI model is deployed.

At processing step PS22, the apparatus having received the update instruction performs a process of acquiring and deploying the target converted AI model from the converted AI model DB.

The AI model of the apparatus having received the update instruction is thus updated.

Note that, in a case where only updating of the AI model is performed, the procedure concludes with the processes up to this point.

In a case where updating of an AI application using the AI model is to be performed in addition to the updating of the AI model, processes mentioned later are executed further.

Specifically, at processing step PS25, the orchestration tool transmits, to a deployment control module, an instruction for downloading an AI application such as updated firmware.

At processing step PS26, the deployment control module transmits an AI application deployment instruction to the Hub. This instruction includes information for identifying a location where the updated AI application is stored.

At processing step PS27, the Hub transmits the deployment instruction to the camera 3.

At processing step PS28, the camera 3 downloads and deploys the updated AI application from a container DB of the deployment control module.

Note that the updating of the AI model operating on the image sensor IS of the camera 3 and the updating of the AI application operating outside the image sensor IS in the camera 3 are performed sequentially in the example explained in the description above.

In addition, whereas the AI application is explained here for simplification of explanation, as mentioned before, the AI application is defined by multiple SW components such as SW components B1, B2, B3, . . . , and Bn, information regarding the location where each SW component is deployed is stored in advance on the cloud-side storage managing section or the like when the AI application is deployed, and the Hub reads out the apparatus (location) where each SW component is deployed from the storage managing section when the Hub performs the process at processing step PS27, and transmits a deployment instruction to the apparatus where the SW component is deployed. At processing step PS28, the apparatus having received the deployment instruction downloads and deploys the updated SW components from the container DB of the deployment control module.

Note that the AI application mentioned here means SW components other than the AI model.

In addition, in a case where both the AI model and the AI application operate on one apparatus, both the AI model and the AI application may be updated collectively as one container. In that case, updating of the AI model and updating of the AI application may be performed not sequentially but simultaneously. Then, it is possible to realize the updating by executing the respective processes of processing steps PS25, PS26, PS27, and PS28.

For example, in a case where the containers of both the AI model and the AI application can be deployed on the image sensor IS of the camera 3, the updating of the AI model and the AI application can be performed by executing the respective processes of processing steps PS25, PS26, PS27, and PS28 as mentioned above.

By performing the processes mentioned above, retraining of an AI model is performed using data of captured images captured in a use environment of a user. Accordingly, an edge-side AI model that can output highly precise recognition results in the use environment of the user can be generated.

In addition, even if an image capturing environment of the camera 3 changes like in a case where a vehicle having 3 as a vehicle-mounted camera mounted thereon is traveling in an area which is different from an area where the vehicle has been traveling until then, in a case where the light amount of incident light incident on the image capturing apparatus changes due to a weather-related or time-related change, or in other cases, retraining of an AI model can be performed appropriately in each occasion, and accordingly, it becomes possible to keep the recognition precision of the AI model without deterioration.

Note that each process mentioned above may be executed not only at the time of retraining of an AI model but also when a system is activated for the first time in a use environment of a user.

### <8. Examples of Screens of Marketplace>

Examples of screens presented to users regarding the marketplace are explained with reference to respective figures.

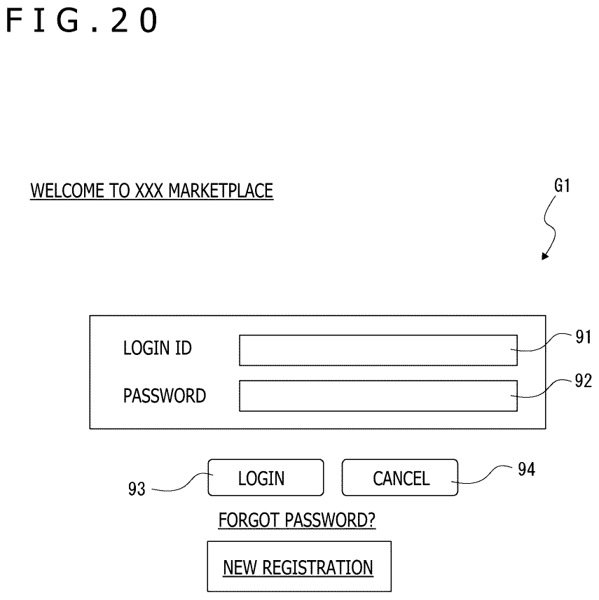

FIG. 20 depicts an example of a login screen G1.

The login screen G1 is provided with an ID input field 91 for inputting a user ID and a password input field 92 for inputting a password.

A login button 93 for logging in and a cancel button 94 for cancelling the login are arranged below the password input field 92.

In addition, further below them, a control element for transitioning to a page for a user who has forgotten the password, a control element for transitioning to a page for performing new user registration, and the like are arranged as appropriate.

When the login button 93 is pressed after an appropriate user ID and password are input, a process of transitioning to a user-specific page is executed at each of the cloud server 1 and the user terminal 2.

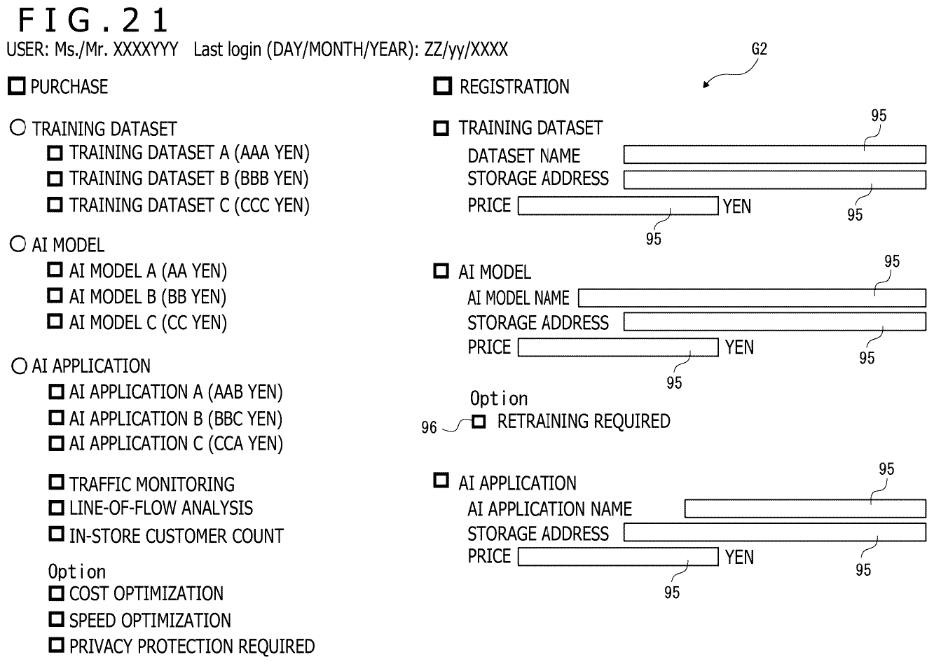

For example, FIG. 21 depicts an example of a screen presented to the AI application developer who uses the application developer terminal 2A or the AI model developer who uses the AI model developer terminal 2C.

Each developer is allowed to purchase, for development, a training dataset, an AI model, and an AI application through the marketplace. In addition, each developer is allowed to register, in the marketplace, AI applications or AI models developed by her/himself.

In a left part on a developer screen G2 depicted in FIG. 21, training datasets, AI models, AI applications, and the like (hereinafter, referred to as “data” collectively) that can be purchased are displayed.

Note that, although not depicted, when a training dataset is to be purchased, an image of the training dataset is displayed on the display, and preparation for training can be completed simply by surrounding, with a frame, only a desired portion of the image by use of an input device such as a mouse and inputting a name.

For example, in a case where it is desired to perform AI training using an image of a cat, an image to which an annotation of a cat is added can be prepared for AI training by surrounding, with a frame, only a portion of the cat on the image and inputting “cat” as a text input.

In addition, it may be made possible to select a purpose like “update (recognize) traffic jam condition,” “update (recognize) accident state,” “update (recognize) fuel prices of each area,” “traffic monitoring,” “line-of-flow analysis,” or “in-store customer count” such that desired data can be found easily. That is, such a display process that only data matching a selected purpose is displayed is executed at each of the cloud server 1 and the user terminal 2.

Note that the developer screen G2 may display a purchase price of each piece of data.

In addition, in a right part on the developer screen G2, input fields 95 for registering a training dataset collected or created by the developer and an AI model and an AI application developed by the developer are provided.

For each piece of data, input fields 95 for inputting its name and the storage location of the data are provided. In addition, for an AI model, a check box 96 for setting whether retraining is necessary or unnecessary is provided.

Note that price setting fields (drawn as input fields 95 in the figure) in which purchase prices that need to be paid when registration-target data is to be purchased can be set or the like may be provided.

In addition, in an upper part on the developer screen G2, a user name, the date of last login, and the like are displayed as part of user information. Note that, other than these, a volume of currencies, the number of points, and the like that the user can use at the time of data purchase may be displayed.

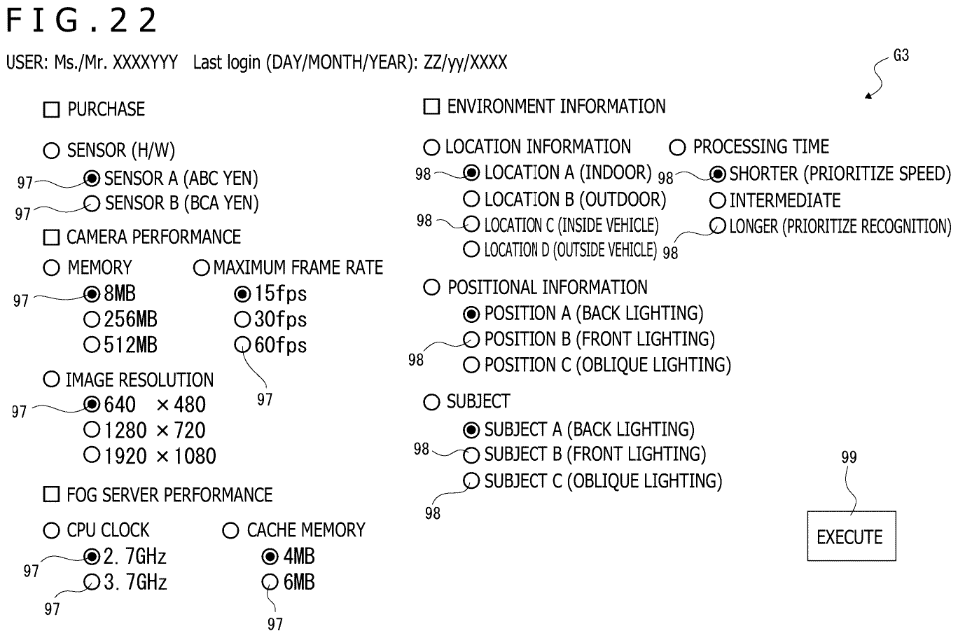

For example, FIG. 22 depicts an example of a user screen G3 presented to a user (an application user mentioned above) who performs various types of analysis or the like by deploying an AI application or an AI model on a camera 3 as an edge-side information processing apparatus managed by her/himself.

The user is allowed to purchase, via the marketplace, the camera 3 to be arranged in a monitoring-target space. For this purpose, in a left part on the user screen G3, radio buttons 97 by which the type or performance of the image sensor IS mounted on the camera 3, the performance of the camera 3, and the like can be selected are arranged.

In addition, the user is allowed to purchase, via the marketplace, an information processing apparatus as a fog server 4. For this purpose, in the left part on the user screen G3, radio buttons 97 for selecting respective types of performance of the fog server 4 are arranged.

In addition, a user who already has a fog server 4 can register the performance of the fog server 4 by inputting here performance information regarding the fog server 4.

The user realizes desired functions by installing a purchased camera 3 (which may be a camera 3 purchased not via the marketplace) at a certain location such as a store run by her/himself. On the marketplace, information regarding an installation location of the camera 3 is allowed to be registered in order to exert the maximum functions of each camera 3.

Radio buttons 98 by which environment information regarding an environment where the camera 3 is to be installed can be selected are arranged in a right part on the user screen G3. By appropriate selection, by the user, of environment information regarding an environment where the camera 3 is to be installed, optimum image capturing settings mentioned above are set for the target camera 3.

Note that, in a case where an installation location of a camera 3 that is planned to purchase has been decided at the time of purchase of the camera 3, by selecting each item in the left part and each item in the right part on the user screen G3, the camera 3 for which image capturing settings optimum for the planned installation location are preset can be purchased.

An execute button 99 is provided on the user screen G3. By pressing the execute button 99, the screen transitions to a confirmation screen for confirming the purchase or a confirmation screen for confirming environment information settings. It is thus made possible for the user to purchase a desired camera 3 or fog server 4 or set environment information regarding the camera 3.

It is possible, on the marketplace, to change environment information regarding each camera 3 in preparation for a time when the installation location of the camera 3 is changed. By re-inputting environment information regarding the installation location of the camera 3 on a change screen, which is not depicted, it becomes possible to set image capturing settings optimum for the camera 3 again.

### <9. Summary>

As explained in each example mentioned above, an information processing apparatus as a cloud-side information processing apparatus (cloud server 1 or management server 5) includes the information acquiring section 10 that acquires information from a sensor of an edge-side information processing apparatus (camera 3 or fog server 4) that performs an inference process using an artificial intelligence model (AI model), the model selecting section 11 that selects an artificial intelligence model to be deployed on the edge-side information processing apparatus, on the basis of purpose information set by a user and the information acquired from the sensor, and the transmission processing section 12 that performs transmission control for transmitting the selected artificial intelligence model to the edge-side information processing apparatus, on the basis of a confirmation result of purchase information regarding the selected artificial intelligence model in an account associated with the user.

With this configuration, it becomes possible to select and deploy an artificial intelligence model for acquiring desired information, on the basis of the information obtained from the edge-side information processing apparatus.

Accordingly, it becomes possible for the edge-side information processing apparatus to obtain appropriate information according to a situation using the selected new artificial intelligence model.

As explained with reference to FIG. 4 and the like, the information acquiring section 10 of the cloud-side information processing apparatus may acquire a result of inference using the selected artificial intelligence model (AI model) from the edge-side information processing apparatus (camera 3 or fog server 4), and the cloud-side information processing apparatus may include the handling processing section that performs a process according to the purpose information by using the result of inference.

For example, in a case where information related to a road condition and obtained from the edge-side information processing apparatus has been acquired, as handling processes, the road condition is reflected in map data, and a route considering the road condition is selected in a service of providing route information using the map data or the like. Then, a user who is using a route information provision service can be guided using, as a recommended route, a route newly selected considering the road condition, and the user is allowed to change the route.

In addition, in a case where information regarding fuel prices of each area has been acquired from the edge-side information processing apparatus, as handling processes, a process of updating a database on which fuel prices of each area are stored and the like can be performed.

As mentioned above, the purpose information may be information regarding a purpose of use of a result of inference of the inference process.

For example, in a case where there is a purpose to cause a road condition obtained as a result of inference to be reflected in map data, an artificial intelligence model (AI model) that can be deployed on the edge-side information processing apparatus (camera 3 or fog server 4) and that is for acquiring the road condition to be reflected in the map data is selected.

Accordingly, it becomes possible for the edge-side information processing apparatus on which the selected artificial intelligence model is deployed to obtain information according to the purpose.

As mentioned above, information related to the sensor may be information regarding a sensor type.

For example, in a case where information regarding fuel prices is displayed using a signboard installed at a storefront, a sidewalk, or the like, an artificial intelligence model (AI model) selected by the edge-side information processing apparatus (camera 3 or fog server 4) is deployed only in a case where the edge-side information processing apparatus has an RGB sensor or the like that can acquire price information.

Accordingly, it is possible to prevent the artificial intelligence model from being undesirably deployed on an edge-side information processing apparatus that cannot use the selected artificial intelligence model.

As mentioned above, information related to the sensor may be positional information as sensing information.

Accordingly, positional information regarding the edge-side information processing apparatus (camera 3 or fog server 4) can be obtained. Hence, it becomes possible to select an artificial intelligence model (AI model) according to the positional information.

As explained with reference to FIG. 13 and the like, the purpose of use may be a purpose to acquire information specific to each area.

Accordingly, information regarding a result of inference obtained from the edge-side information processing apparatus (camera 3 or fog server 4) and positional information regarding the edge-side information processing apparatus can be associated with each other. Then, by obtaining multiple pieces of such information in which positional information and a result of inference are associated with each other, for example, it becomes possible to map, as information specific to each area, information regarding a road condition or the like on map data.

As explained with reference to FIG. 13 and the like, the purpose of use may be a purpose to obtain information regarding a road condition.

For example, when a disaster such as an earthquake occurs, an artificial intelligence model (AI model) for acquiring information related to a road condition is selected at an edge-side information processing apparatus (camera 3 or fog server 4) that is present in each area. Then, by deploying these on an edge-side information processing apparatus present in each area, it becomes possible to map the road condition of each area on map data. As mentioned above, examples of the road condition include information representing the degree of damage to roads and whether or not there is damage to roads, information representing a traffic jam condition, and the like.

As explained with reference to FIG. 13 and the like, the purpose of use may be a purpose to obtain price information regarding a fuel to be used for a vehicle.

For example, in a case where fuel prices are different between areas, an artificial intelligence model (AI model) for acquiring information regarding fuel prices is selected at an edge-side information processing apparatus (camera 3 or fog server 4) that is present in each area. Then, by deploying these on an edge-side information processing apparatus present in each area, it becomes possible to map fuel prices of each area on map data.

As explained regarding each example mentioned above, an information processing apparatus as an edge-side information processing apparatus (camera 3 or fog server 4) includes a transmission processing section (control section 33) that transmits information related to a sensor to a server apparatus (cloud-side information processing apparatus), a reception processing section (control section 33) that receives an artificial intelligence model (AI model) selected on the basis of purpose information and the transmitted information related to the sensor, and an inference processing section (AI image processing section 44) that performs an inference process using the received artificial intelligence model, and the transmission processing section transmits a result of inference of the inference process to the server apparatus.

With this configuration, the edge-side information processing apparatus can perform an inference process using the new artificial intelligence model selected by the server apparatus. Accordingly, it becomes possible to transmit, to the server apparatus, a result of inference according to a purpose of the server apparatus.

As explained with reference to FIG. 4 and the like, the transmission processing section (control section 33) of the edge-side information processing apparatus (camera 3 or fog server 4) as the information processing apparatus may transmit the information related to the sensor at the time of activation.

With this configuration, the server apparatus (cloud-side information processing apparatus) can select an artificial intelligence model (AI model) in response to, as a trigger, reception of the information related to the sensor from the information processing apparatus such as a camera 3. Accordingly, the server apparatus need not always monitor whether or not the information processing apparatus is activated, and a processing load on the server apparatus can be reduced.

The information processing system 100 mentioned above includes the server apparatus (cloud server 1 or management server 5) and the edge-side information processing apparatus (camera 3 or fog server 4).

Then, the server apparatus has the information acquiring section 10 that acquires information from a sensor of an edge-side information processing apparatus, the model selecting section 11 that selects an artificial intelligence model (AI model) to be deployed on the edge-side information processing apparatus, on the basis of purpose information set by a user and the information acquired from the sensor, and the transmission processing section 12 that performs transmission control for transmitting the selected artificial intelligence model to the edge-side information processing apparatus, on the basis of a confirmation result of purchase information regarding the selected artificial intelligence model in an account associated with the user.

In addition, the edge-side information processing apparatus has a transmission processing section (control section 33) that performs transmission control for transmitting information acquired from the sensor to the server apparatus, a reception processing section (control section 33) that performs reception control for receiving the selected artificial intelligence model, and an inference processing section (AI image processing section 44) that performs an inference process using the received artificial intelligence model.

Such an information processing system 100 makes it possible to collect information as results of inference using an edge-side information processing apparatus positioned at each location and use the information for various types of analysis or presentation of information.

An information processing method in the present technology is executed by a computer apparatus as a cloud-side information processing apparatus, the information processing method including a process of acquiring information from a sensor of an edge-side information processing apparatus that performs an inference process using an artificial intelligence model, a process of selecting an artificial intelligence model to be deployed on the edge-side information processing apparatus, on the basis of purpose information set by a user and the information acquired from the sensor, and a process of performing transmission control for transmitting the selected artificial intelligence model to the edge-side information processing apparatus, on the basis of a confirmation result of purchase information regarding the selected artificial intelligence model in an account associated with the user.

In addition, an information processing method in the present technology is executed by a computer apparatus as an edge-side information processing apparatus, the information processing method including a process of performing transmission control for transmitting information acquired from a sensor to a server apparatus, a process of performing reception control for receiving an artificial intelligence model selected on the basis of purpose information set by a user and the information acquired from the sensor, an inference process using the received artificial intelligence model, and a process of performing transmission control for transmitting a result of inference of the inference process to the server apparatus.

A program of the present technology causes a computation processing section of a cloud-side information processing apparatus (cloud server 1, management server 5) to execute the respective processes depicted in FIG. 6, FIG. 8, and FIG. 10.

In addition, a program of the present technology causes a computation processing section of an edge-side information processing apparatus (camera 3, fog server 4) to execute the respective processes depicted in FIG. 5, FIG. 7, and FIG. 9.

Such a program can be recorded in advance on an HDD (Hard Disk Drive) as a recording medium built in equipment such as a computer apparatus, a ROM in a microcomputer having a CPU, or the like. Alternatively, it is also possible to temporarily or permanently store (record) the program on a removable recording medium such as a flexible disc, a CD-ROM (Compact Disk Read Only Memory), an MO (Magneto Optical) disc, a DVD (Digital Versatile Disc), a Blu-ray disc (registered trademark), a magnetic disc, a semiconductor memory, or a memory card. Such a removable recording medium can be provided as what is generally called package software.

In addition, other than being installed on a personal computer or the like from a removable recording medium, such a program can also be downloaded from a download site via a network such as a LAN (Local Area Network) or the Internet.

Note that advantages described in the present specification are merely illustrated as examples and are not limitative, and there may be other advantages.

In addition, the respective examples mentioned above may be combined in any manner, and, even in a case where various combinations are used, various effects and advantages mentioned above can be attained.

### <10. Present Technology>

The present technology can also adopt configurations like the ones below.

(1)

An information processing apparatus including:
an information acquiring section that acquires information from a sensor of an edge-side information processing apparatus that performs an inference process using an artificial intelligence model;
a model selecting section that selects an artificial intelligence model to be deployed on the edge-side information processing apparatus, on the basis of purpose information set by a user and the information acquired from the sensor; and
a transmission processing section that performs transmission control for transmitting the selected artificial intelligence model to the edge-side information processing apparatus, on the basis of a confirmation result of purchase information regarding the selected artificial intelligence model in an account associated with the user.
   (2)

The information processing apparatus according to (1) above, in which
the information acquiring section acquires a result of inference using the selected artificial intelligence model from the edge-side information processing apparatus, and
the information processing apparatus includes a handling processing section that performs a process according to the purpose information by using the result of inference.
   (3)

The information processing apparatus according to (1) or (2) above, in which the purpose information is information regarding a purpose of use of a result of inference of the inference process.

(4)

The information processing apparatus according to (3) above, in which information related to the sensor is information regarding a sensor type.

(5)

The information processing apparatus according to (3) or (4) above, in which information related to the sensor is positional information as sensing information.

(6)

The information processing apparatus according to (5) above, in which the purpose of use is a purpose to acquire information specific to each area.

(7)

The information processing apparatus according to any of (3) to (6) above, in which the purpose of use is a purpose to obtain information regarding a road condition.

(8)

The information processing apparatus according to any of (3) to (6) above, in which the purpose of use is a purpose to obtain price information regarding a fuel to be used for a vehicle.

(9)

An information processing apparatus including:
a transmission processing section that transmits information related to a sensor to a server apparatus;
a reception processing section that receives an artificial intelligence model selected on the basis of purpose information and the transmitted information related to the sensor; and
an inference processing section that performs an inference process using the received artificial intelligence model, in which
the transmission processing section transmits a result of inference of the inference process to the server apparatus.
   (10)

The information processing apparatus according to (9) above, in which the transmission processing section transmits the information related to the sensor at a time of activation.

(11)

The information processing apparatus according to (9) or (10) above, in which the information related to the sensor is positional information as sensing information.

(12)

An information processing system including:
a server apparatus; and
an edge-side information processing apparatus, in which
the server apparatus has
   an information acquiring section that acquires information from a sensor of the edge-side information processing apparatus,
   a model selecting section that selects an artificial intelligence model to be deployed on the edge-side information processing apparatus, on the basis of purpose information set by a user and the information acquired from the sensor, and
   a transmission processing section that performs transmission control for transmitting the selected artificial intelligence model to the edge-side information processing apparatus, on the basis of a confirmation result of purchase information regarding the selected artificial intelligence model in an account associated with the user, and
the edge-side information processing apparatus has
   a transmission processing section that performs transmission control for transmitting the information acquired from the sensor to the server apparatus,
   a reception processing section that performs reception control for receiving the selected artificial intelligence model, and
   an inference processing section that performs an inference process using the received artificial intelligence model.

### REFERENCE SIGNS LIST

1: Cloud server (information processing apparatus, server apparatus)
3: Camera (edge-side information processing apparatus, information processing apparatus)
4: Fog server (edge-side information processing apparatus, information processing apparatus)
5: Management server (information processing apparatus, server apparatus)
10: Information acquiring section
11: Model selecting section
12: Transmission processing section
13: Handling processing section
33: Control section (transmission processing section, reception processing section)
44: AI image processing section (inference processing section)
100: Information processing system

1. An information processing apparatus comprising:
an information acquiring section that acquires information from a sensor of an edge-side information processing apparatus that performs an inference process using an artificial intelligence model;
a model selecting section that selects an artificial intelligence model to be deployed on the edge-side information processing apparatus, on a basis of purpose information set by a user and the information acquired from the sensor; and
a transmission processing section that performs transmission control for transmitting the selected artificial intelligence model to the edge-side information processing apparatus, on a basis of a confirmation result of purchase information regarding the selected artificial intelligence model in an account associated with the user.

2. The information processing apparatus according to claim 1, wherein
the information acquiring section acquires a result of inference using the selected artificial intelligence model from the edge-side information processing apparatus, and
the information processing apparatus includes a handling processing section that performs a process according to the purpose information by using the result of inference.

3. The information processing apparatus according to claim 1, wherein the purpose information is information regarding a purpose of use of a result of inference of the inference process.

4. The information processing apparatus according to claim 3, wherein information related to the sensor is information regarding a sensor type.

5. The information processing apparatus according to claim 3, wherein information related to the sensor is positional information as sensing information.

6. The information processing apparatus according to claim 5, wherein the purpose of use is a purpose to acquire information specific to each area.

7. The information processing apparatus according to claim 3, wherein the purpose of use is a purpose to obtain information regarding a road condition.

8. The information processing apparatus according to claim 3, wherein the purpose of use is a purpose to obtain price information regarding a fuel to be used for a vehicle.

9. An information processing apparatus comprising:
a transmission processing section that transmits information related to a sensor to a server apparatus;
a reception processing section that receives an artificial intelligence model selected on a basis of purpose information and the transmitted information related to the sensor; and
an inference processing section that performs an inference process using the received artificial intelligence model, wherein
the transmission processing section transmits a result of inference of the inference process to the server apparatus.

10. The information processing apparatus according to claim 9, wherein the transmission processing section transmits the information related to the sensor at a time of activation.

11. The information processing apparatus according to claim 9, wherein the information related to the sensor is positional information as sensing information.

12. An information processing system comprising:
a server apparatus; and
an edge-side information processing apparatus, wherein the server apparatus has
an information acquiring section that acquires information from a sensor of the edge-side information processing apparatus,
a model selecting section that selects an artificial intelligence model to be deployed on the edge-side information processing apparatus, on a basis of purpose information set by a user and the information acquired from the sensor, and
a transmission processing section that performs transmission control for transmitting the selected artificial intelligence model to the edge-side information processing apparatus, on a basis of a confirmation result of purchase information regarding the selected artificial intelligence model in an account associated with the user, and
the edge-side information processing apparatus has
a transmission processing section that performs transmission control for transmitting the information acquired from the sensor to the server apparatus,
a reception processing section that performs reception control for receiving the selected artificial intelligence model, and
an inference processing section that performs an inference process using the received artificial intelligence model.
